(19) United States
(12) Patent Application Publication
(10) Pub. No.: US 2024/0298253 A1
(43) Pub. Date: Sep. 5, 2024

(54) Network Slice for Access of Wireless Device to a Network

(71) Applicant: Ofinno, LLC, Reston, VA (US)

(72) Inventors: Peyman Talebi Fard, Vienna, VA (US); Kyungmin Park, Vienna, VA (US); Esmael Hejazi Dinan, McLean, VA (US); SungDuck Chun, Fairfax, VA (US); Taehun Kim, Fairfax, VA (US); Weihua Qiao, Herndon, VA (US)

(73) Assignee: Ofinno, LLC, Reston, VA (US)

(21) Appl. No.: 18/647,605

(22) Filed: Apr. 26, 2024

Related U.S. Application Data
(63) Continuation of application No. PCT/US2022/048814, filed on Nov. 3, 2022.
(60) Provisional application No. 63/275,686, filed on Nov. 4, 2021.

(51) Int. Cl. H04W 48/18; H04W 48/14

(52) U.S. Cl. CPC H04W 48/18; H04W 48/14

(57) ABSTRACT

An access and mobility management function of an overlay network can send, to a network slice selection function, a request for selection of one or more allowed network slices of a wireless device. The request for selection can indicate that an access of the wireless device to the overlay network is via an underlay network. The access and mobility management function can receive, from the network slice selection function, one or more network slice identifiers of the one or more allowed network slices for the access of the wireless device to the overlay network via the underlay network.

### CROSS-REFERENCE TO RELATED APPLICATIONS

This application is a continuation of International Application No. PCT/US2022/048814, filed Nov. 3, 2022, which claims the benefit of U.S. Provisional Application No. 63/275,686, filed Nov. 4, 2021, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15A illustrates an example embodiment of a present disclosure.

FIG. 15B illustrates an example embodiment of a present disclosure.

FIG. 15C illustrates an example embodiment of a present disclosure.

FIG. 16 illustrates an example embodiment of a present disclosure.

FIG. 17 illustrates an example embodiment of a present disclosure.

FIG. 18A illustrates an example embodiment of a present disclosure.

FIG. 18B illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

FIG. 26 illustrates an example embodiment of a present disclosure.

FIG. 27 illustrates an example embodiment of a present disclosure.

FIG. 28 illustrates an example embodiment of a present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “ at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

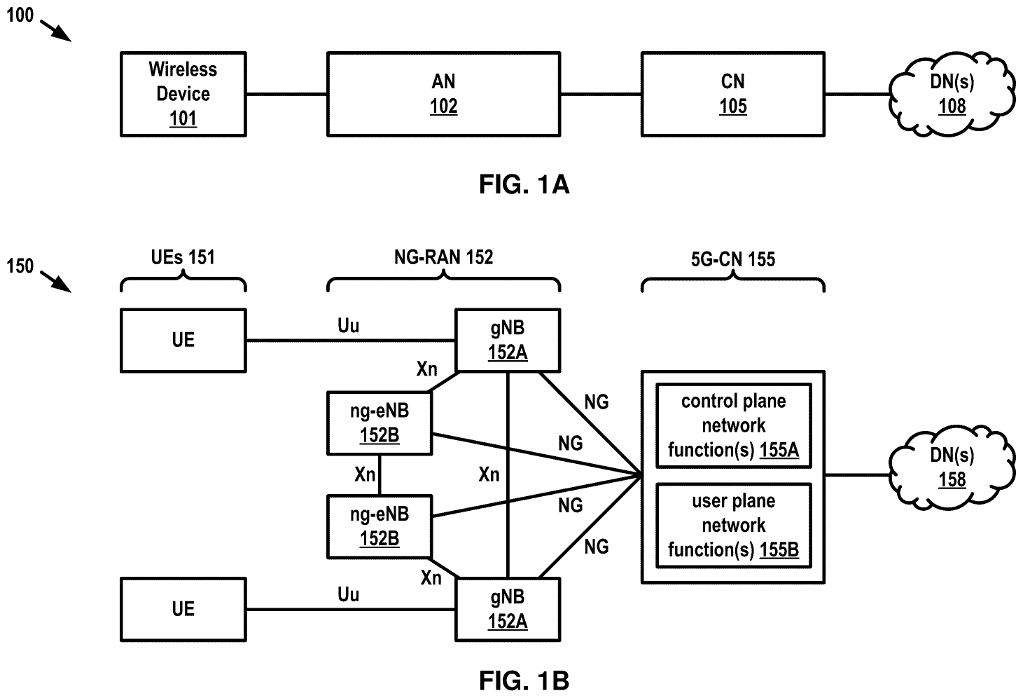

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, Wi-Fi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

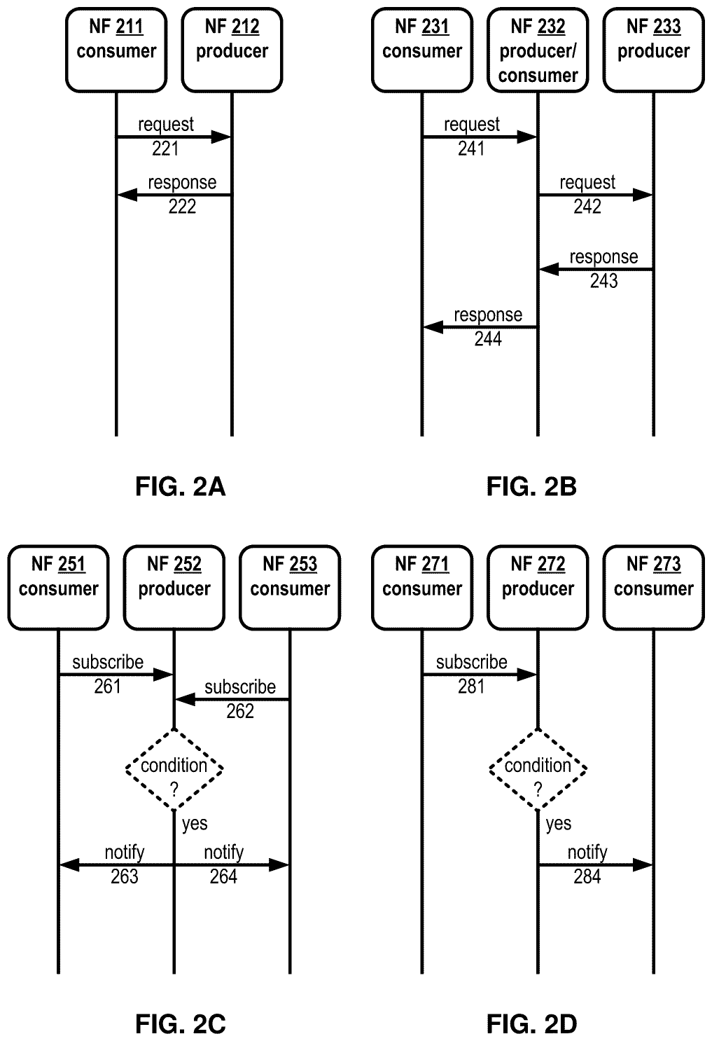

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

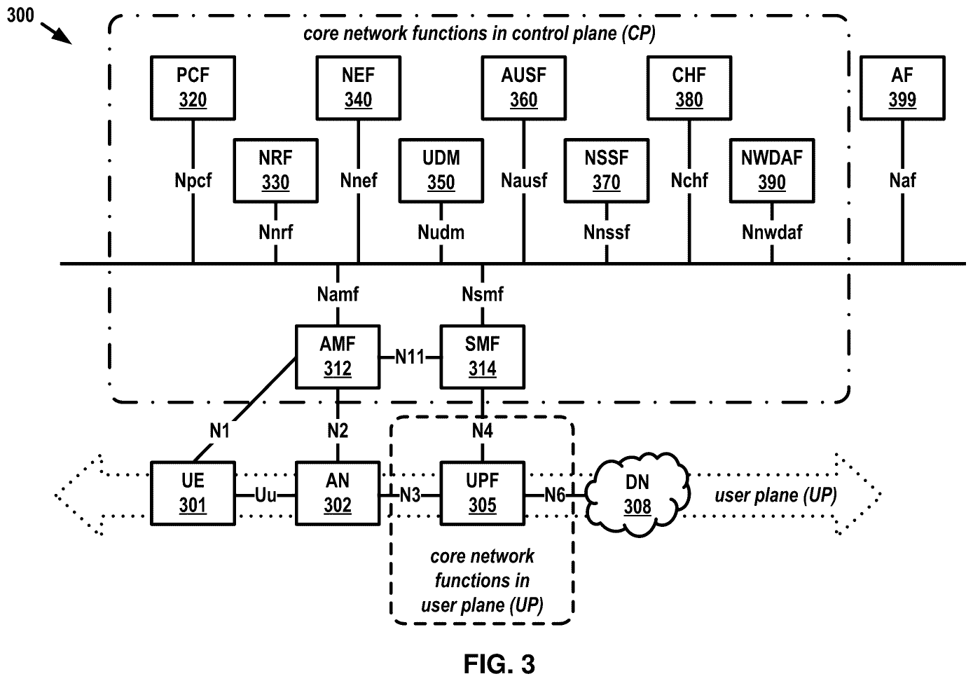

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

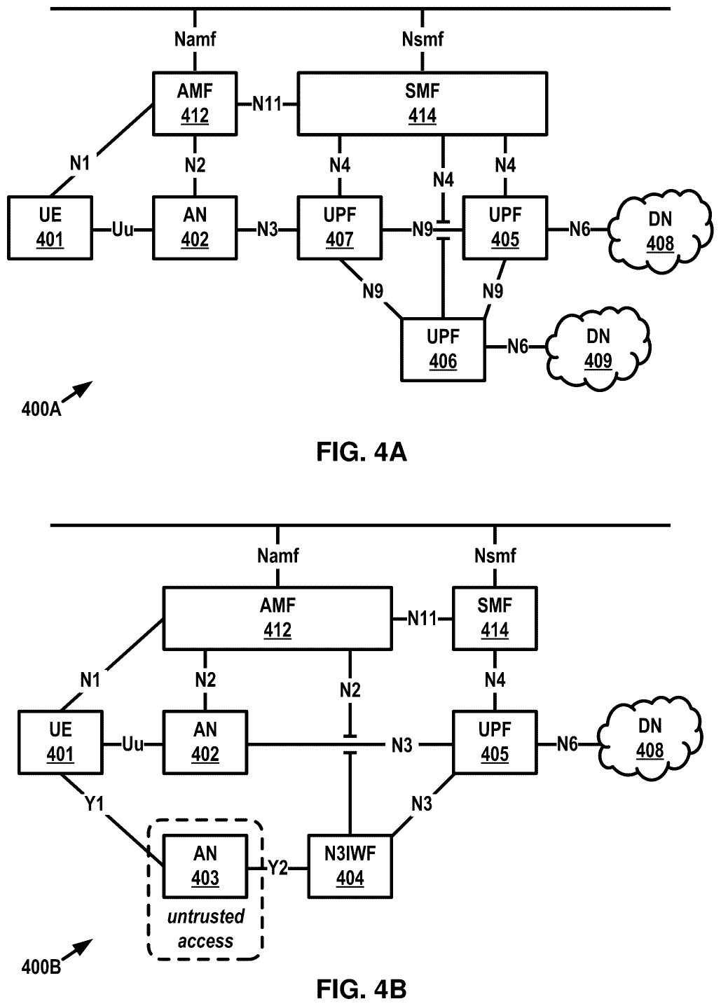

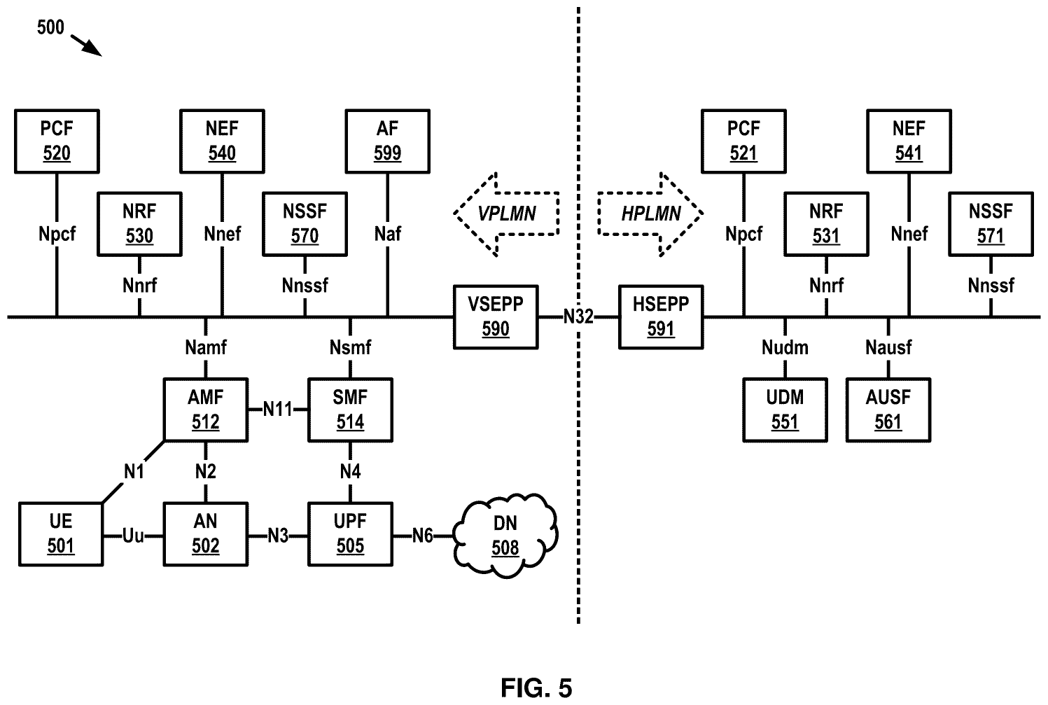

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

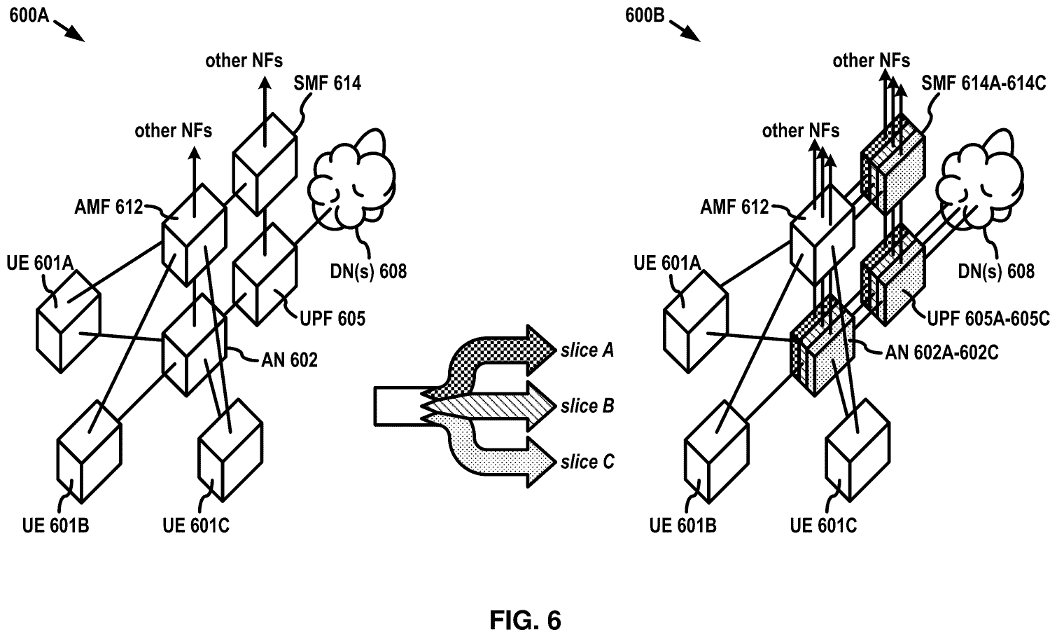

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

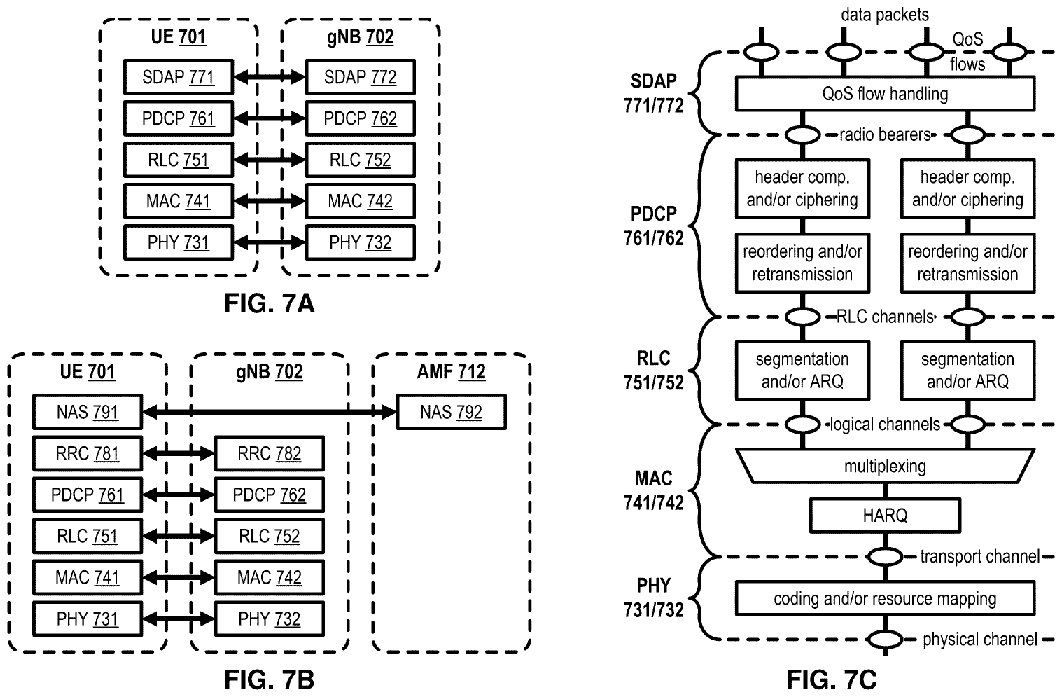

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QOS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

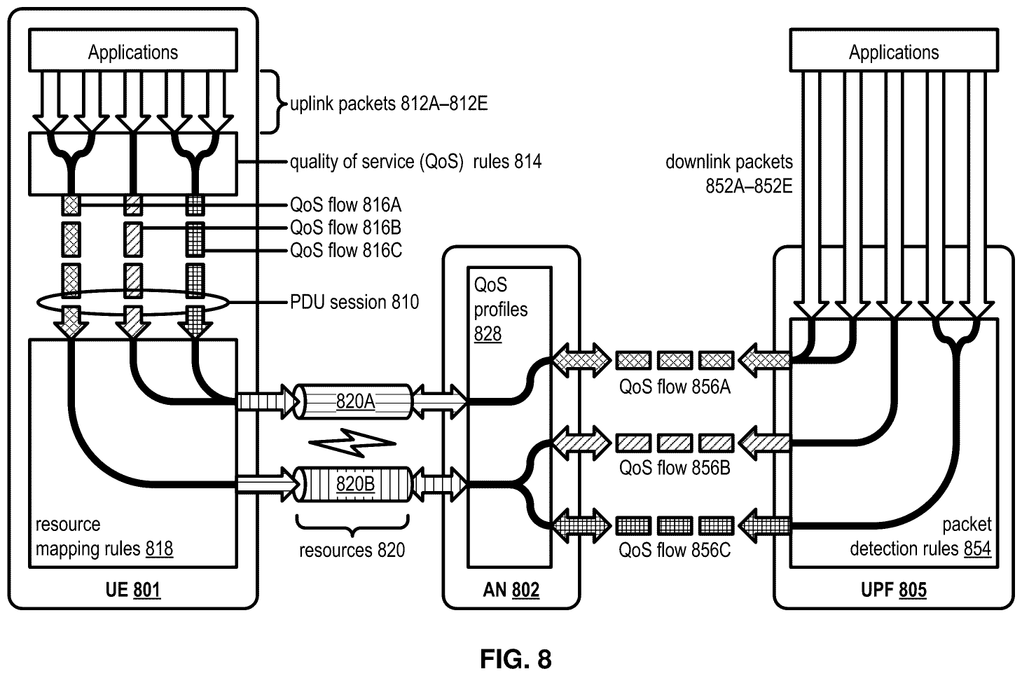

FIG. 8 illustrates an example of a quality of service (QOS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

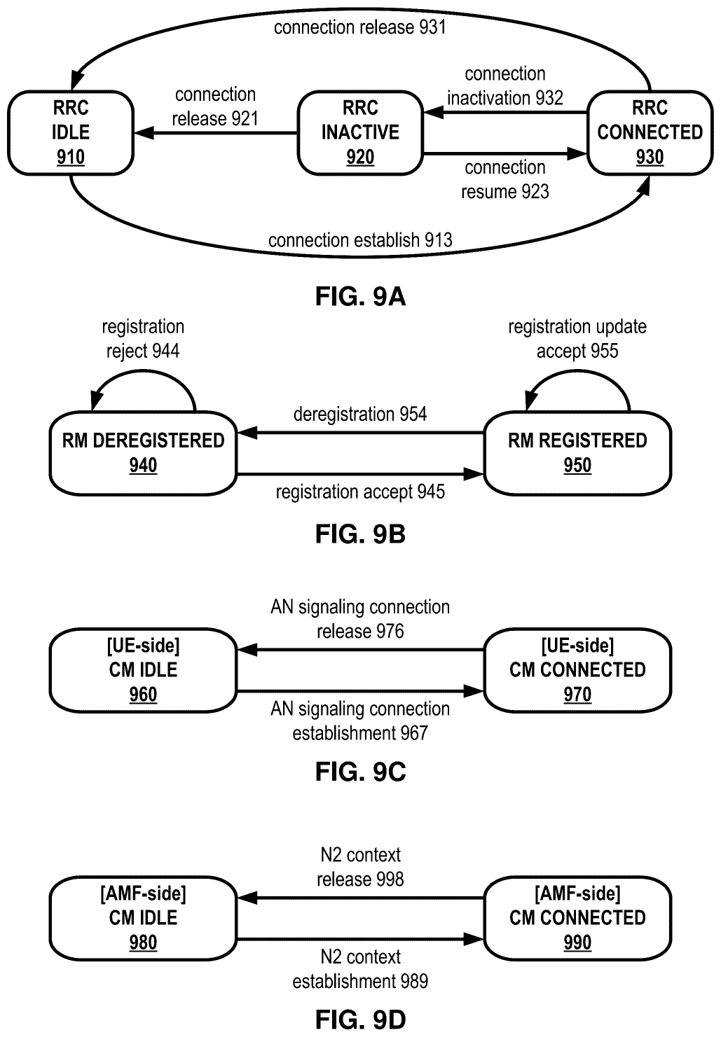

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non-access stratum (NAS) (which can also be referred to as non access stratum) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF may establish an N2 context of the UE (N2 context establishment 989). When the UE transitions from CM connected 990 to CM idle 980, the AMF may release the N2 context of the UE (N2 context release 998).

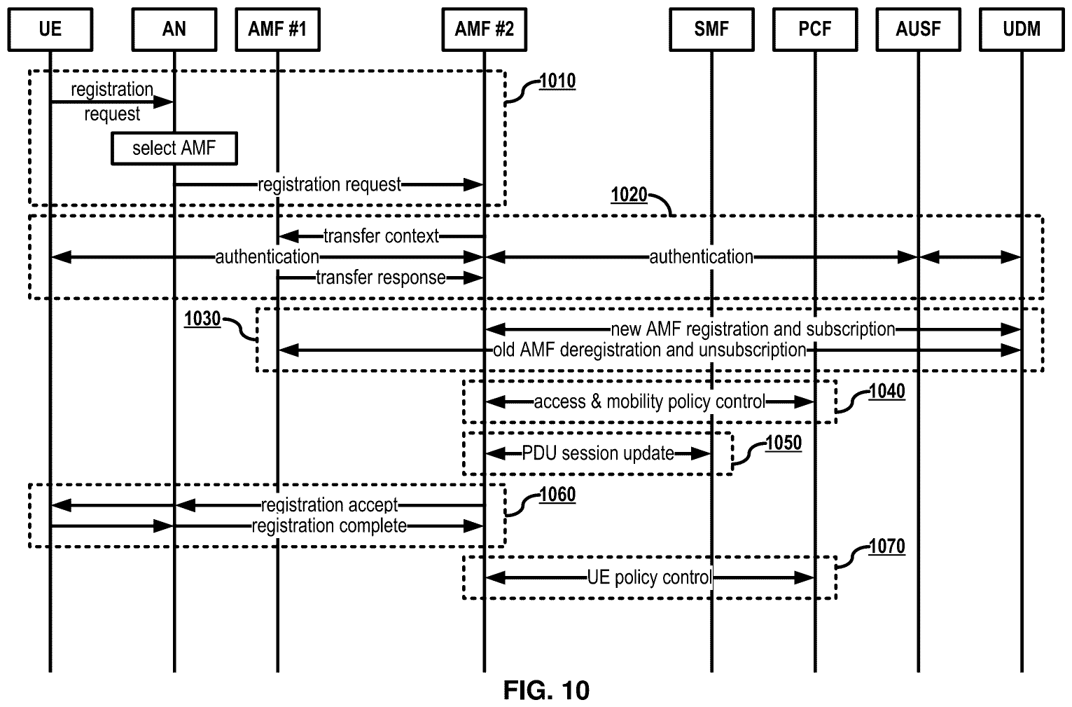

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

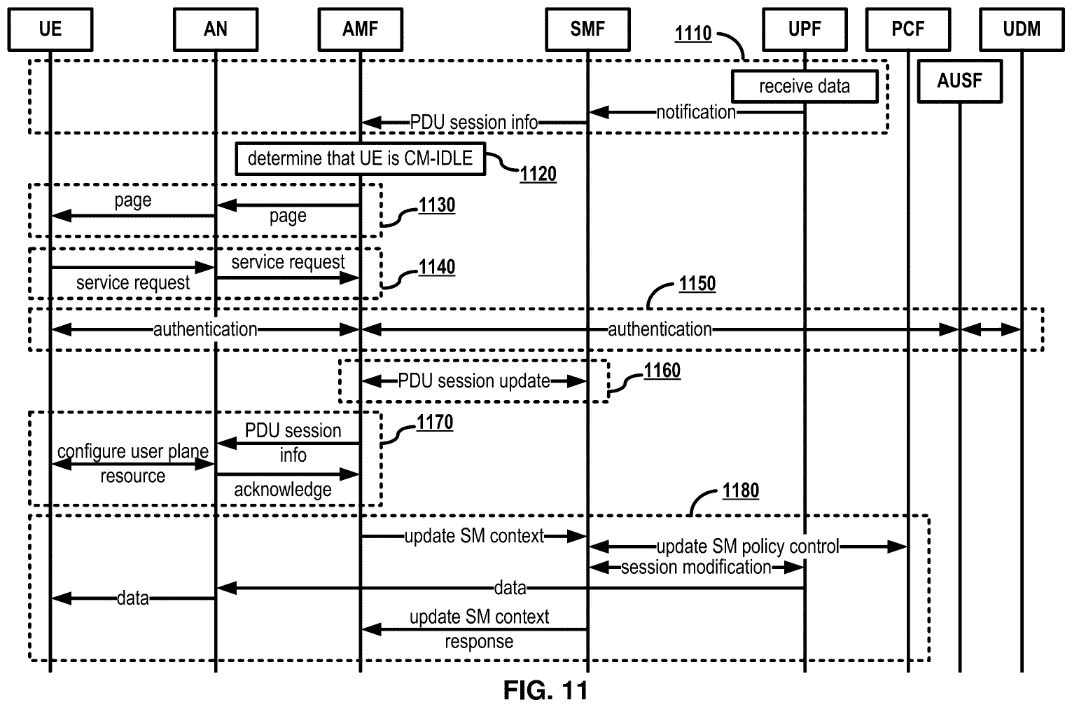

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

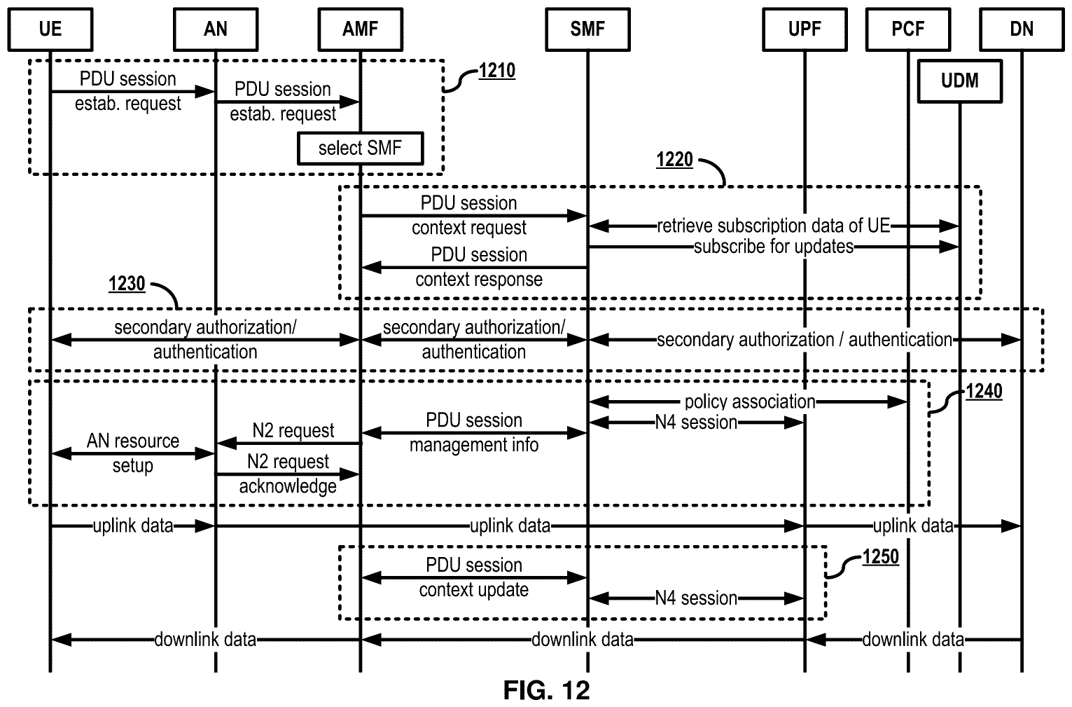

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

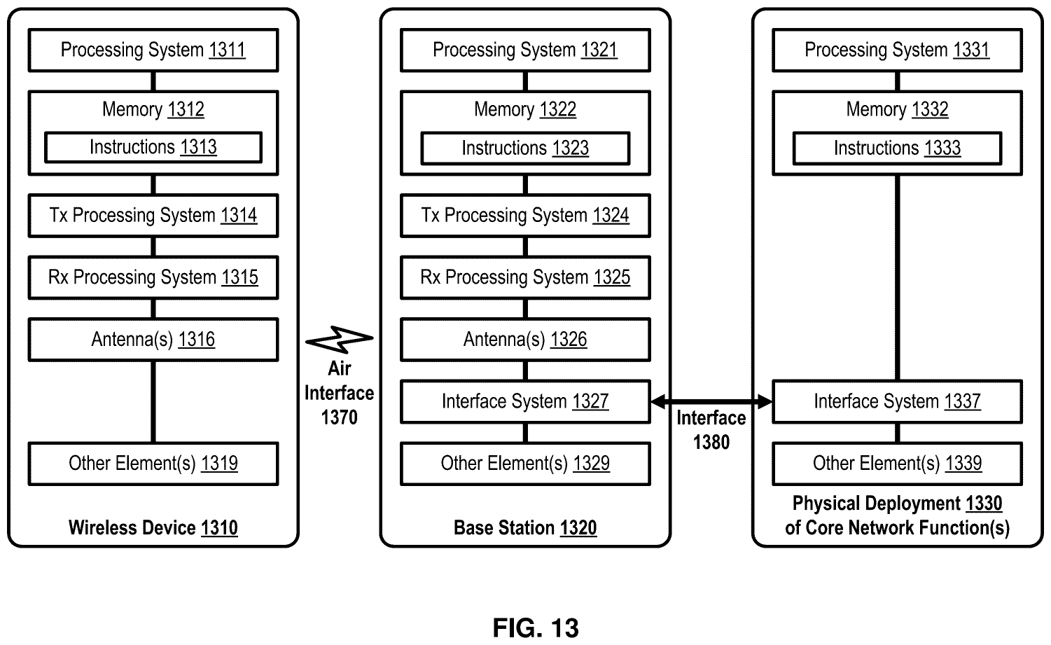

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

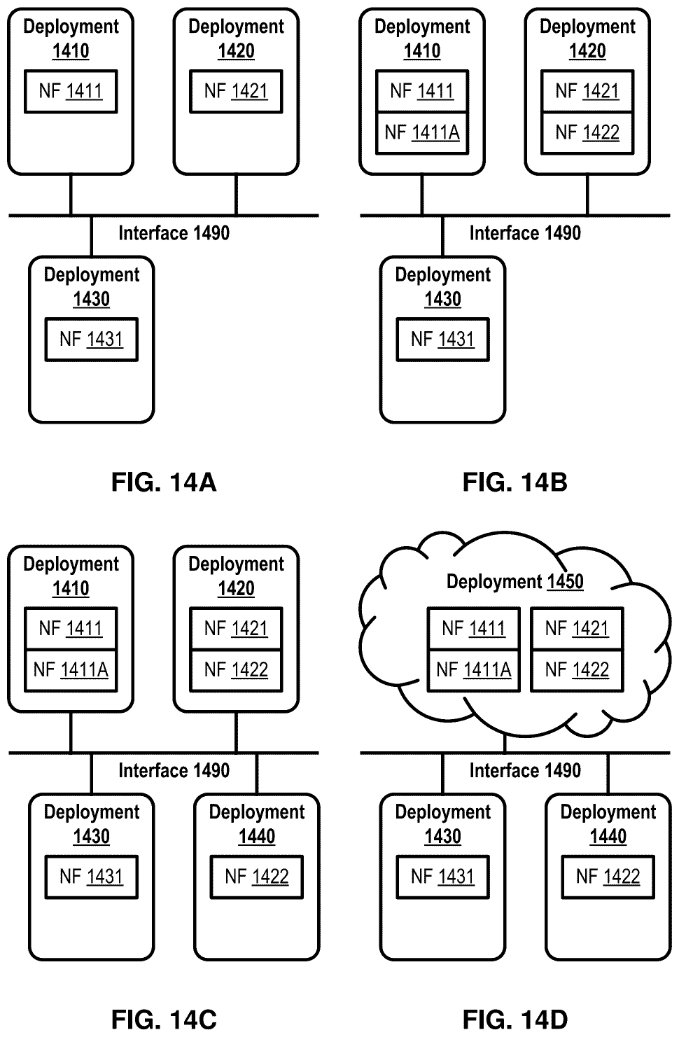

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

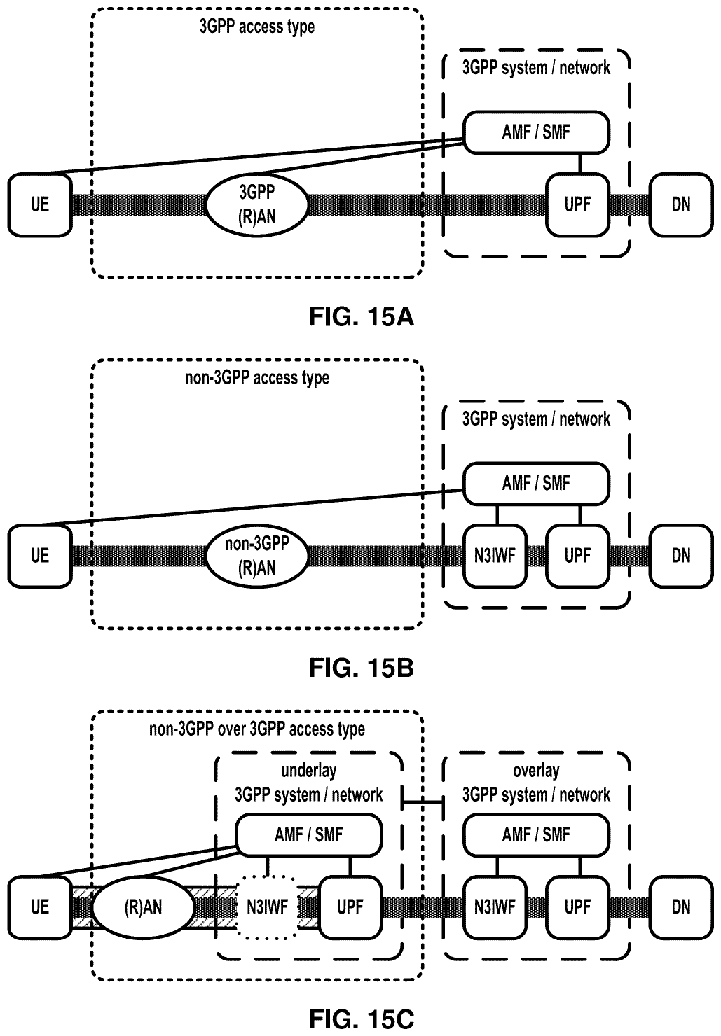

In an example embodiment as depicted in FIG. 15A, FIG. 15B and FIG. 15C, a UE may access a network via different access types. The UE may access the network via a 3GPP access type as in FIG. 15A. A 3GPP access type may comprise GRAN: GSM radio access network (GRAN), EDGE packet radio services with GRAN (GERAN), UMTS radio access network (UTRAN), E-UTRAN: The Long Term Evolution (LTE) high speed and low latency radio access network, New Radio (NR), 5G NR, and/or the like.

In an example, as depicted in FIG. 15B, a non-3GPP (N3GPP) access type may be employed. Examples of N3GPP access type may comprise trusted or untrusted Wi-Fi access, IEEE based access, wireline access, fixed access, WiMAX, and/or the like. In an example, N3IWF-Non-3GPP Interworking Function may be employed for access of a UE to the network via N3GPP access. The N3IWF may be employed for interworking between untrusted non-3GPP networks and the 5G Core. As such, the N3IWF may support both N2 and N3 based connectivity to the core, whilst supporting IPSec connectivity towards the UE.

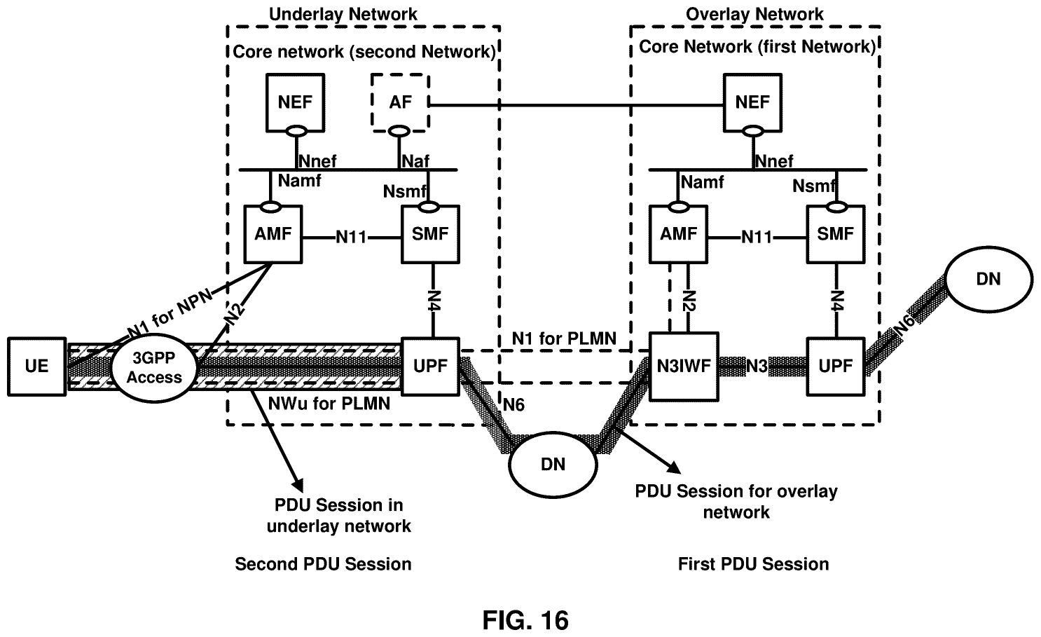

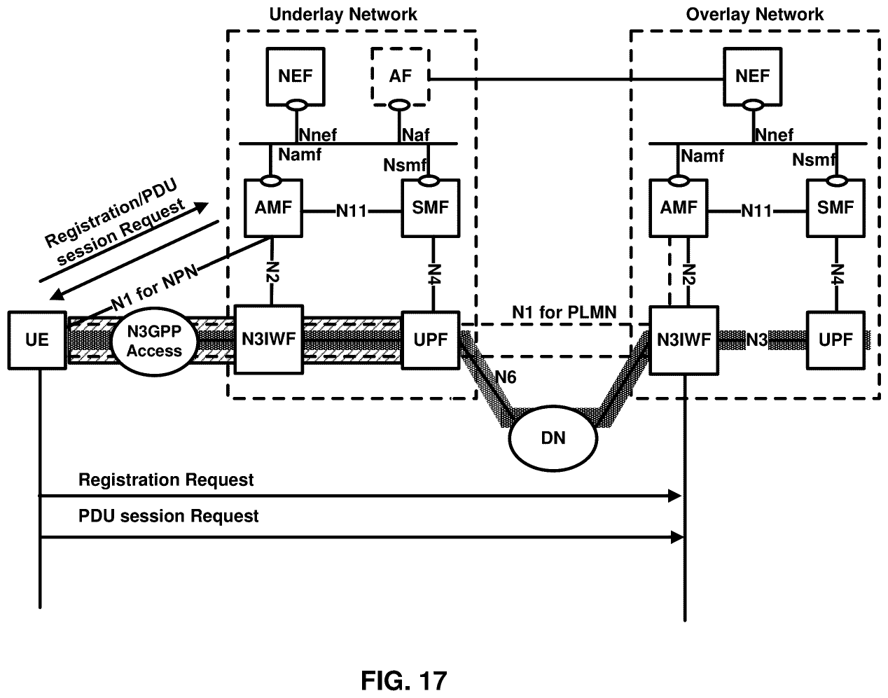

In an example embodiment as depicted in FIG. 15C, the UE may access the network (e.g., a PLMN, SNPN/NPN, etc.) via another network (referred to as an underlay network e.g., a PLMN, SNPN/NPN, and/or the like) such as a 3GPP network/system. Access of the UE to the network via an underlay network may be referred to as an extended access type, an auxiliary access type, an underlay network access type, an intermediate access type, and/or the like. In an example, the extended access type may refer to access of the UE to an overlay network (or a first network) via a 3GPP access of an underlay network (a second network). In an example, the extended access type may refer to access of the UE to the overlay network (or the first network) via a N3GPP access of the underlay network (the second network). For example, the UE may access a network via 3GPP access or via non-3GPP access. In an example as depicted in FIG. 16, the UE may access an underlay network via the 3GPP access in order to access an overlay network via non-3GPP interworking function of the overlay network. As depicted in FIG. 17, the UE may access a network via the non-3GPP access of the underlay network in order to access an overlay network via non-3GPP interworking function of the overlay network. In an example, the extended access type may be a third access type such as underlay access, non-3GPP access over (via) 3GPP access, IPsec access over 3GPP access, and/or the like. In an example, an extended access type indication may be an indication that a UE may access a network via an underlay network. In an example, an extended access type indication may be an indication that an overlay network may be involved. The extended access type indication may comprise an indication that the UE may employ configuration parameters from at least one of a first network (overlay network) and a second network (underlay network). The configuration parameters may comprise UE route selection policy URSP, TAI, registration area, mobility restrictions, and/or the like.

In an example embodiment, the extended access type or extended access type indication may refer to a RAT type whereby the RAT type may be within a 3GPP access or a N3GPP access. In an example, when the extended access type refers to the RAT type, the RAT type may indicate that the access is via a user plane of the underlay network (e.g., a 3GPP network/system) and the 3GPP access type or N3GPP access type of the underlay network may be employed. In an example embodiment, access via an underlay network to an overlay network may be defined and/or interpreted as a RAT type. In an example, the RAT type may be the extended access type.

In an example embodiment, mobility restrictions may be employed to restrict mobility handling or service access of a UE. The mobility restriction functionality is provided by the UE, the radio access network and the core network. In an example, service area restrictions and handling of forbidden areas for CM-IDLE state and, for CM-CONNECTED state when in RRC Inactive state may be executed by the UE based on information received from the core network. Mobility restrictions for CM-CONNECTED state when in RRC-Connected state may be executed by the radio access network and the core network. In CM-CONNECTED state, the core network may provide mobility restrictions to the radio access network within mobility restriction list.

In an example embodiment, mobility restrictions may comprise RAT restriction, forbidden area, service area restrictions, core network type restriction and closed access group information as follows.

In an example, RAT restriction may define the 3GPP Radio Access Technology(ies), a UE is not allowed to access in a PLMN. In a restricted RAT a UE based on subscription is not permitted access to the network for this PLMN. For CM-CONNECTED state, when radio access network determines target RAT and target PLMN during Handover procedure, it should take per PLMN RAT restriction into consideration. The RAT restriction may be enforced in the network, and may (or may not) be provided to the UE.

In an example, in a forbidden area, the UE, based on subscription, may not be permitted to initiate any communication with the network for this PLMN. The UE behavior in terms of cell selection, RAT selection and PLMN selection may depend on the network response that informs the UE of forbidden area. A forbidden area may apply either to 3GPP access or to non-3GPP access. If the N3GPP TAI is forbidden in a PLMN, non-3GPP Access may be forbidden altogether in this PLMN.

Service area restriction may define areas in which the UE may or may not initiate communication with the network as follows: Allowed Area: in an Allowed Area, the UE is permitted to initiate communication with the network as allowed by the subscription. Non-Allowed Area: in a Non-Allowed Area a UE is service area restricted based on subscription. The UE and the network are not allowed to initiate Service Request, or any connection requests for user plane data, control plane data, exception data reporting, or SM signaling (except for PS Data Off status change reporting) to obtain user services that are not related to mobility. The UE may (or may not) use the entering of a Non-Allowed Area as a criterion for Cell Reselection, a trigger for PLMN Selection or Domain selection for UE originating sessions or calls. The UE in a Non-Allowed Area may respond to core network paging or NAS notification message from non-3GPP access with service request and RAN paging. The UE in a Non-Allowed Area may initiate MA PDU Session establishment or activation over a non-3GPP access other than wireline access, but the User Plane resources on the 3GPP access for the MA-PDU may not be established or activated.

In an example, core Network type restriction may defines whether UE is allowed to connect to 5GC only, EPC only, both 5GC and EPC for this PLMN. The Core Network type restriction when received applies in the PLMN either to both 3GPP and non-3GPP Access Types or to non-3GPP Access Type only. The core network type restriction may be used e.g. in network deployments where the E-UTRAN connects to both EPC and 5GC. When the core network type restriction applies to non-3GPP Access Type, the UE may be restricted from using any connectivity to an N3IWF.

In an example, closed access group (CAG) information may identify a group of subscribers who are permitted to access one or more CAG cells associated to the CAG. CAG may be employed for public network integrated non-public network (PNI-NPNs) to prevent UE(s), which are not allowed to access the NPN via the associated cell(s), from automatically selecting and accessing the associated CAG cell(s).

For a given UE, the core network determines the Mobility Restrictions based on UE subscription information, UE location and/or local policy (e.g. if the HPLMN has not deployed 5GC, HPLMN ID of the UE and the operator's policy are used in the VPLMN for determining the Core Network type restriction). The Mobility Restriction may change due to e.g., UE's subscription, location change and local policy. Optionally the service area restrictions or the non-allowed area may in addition be fine-tuned by the PCF e.g., based on UE location, PEI and network policies. Service area restrictions may be updated during a registration procedure or UE configuration update procedure.

In an example embodiment as depicted in FIG. 16 and FIG. 17, a UE may access a first network (overlay network) services via a second network (e.g., non-public network, PLMN, underlay network). The UE may first obtain IP connectivity by registering with the underlay network. Then the UE may obtain connectivity to the 5GC in the overlay network via an interworking function (e.g., a proxy, N3IWF, and/or the like). The underlay network may deploy a 3GPP RAT (as in FIG. 16), N3GPP RAT (as in FIG. 17), and/or the like.

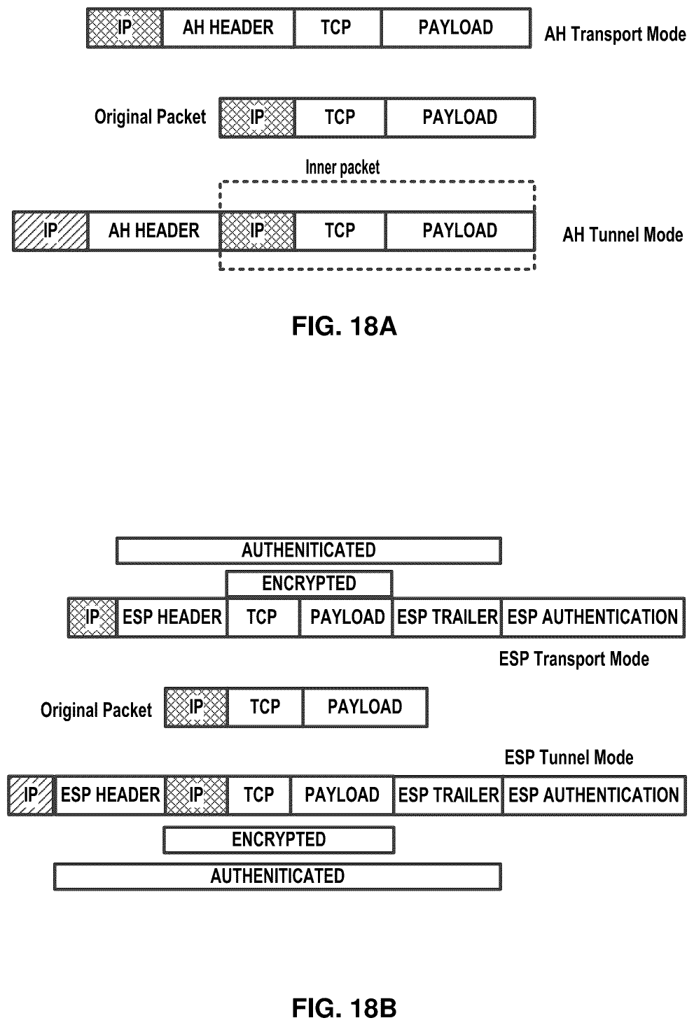

In an example embodiment as depicted in FIG. 18A and FIG. 18B, Internet Protocol Security (IPsec) may be a secure network protocol suite that authenticates and encrypts the packets of data to provide secure encrypted communication between two computers over an Internet Protocol network. IPsec may include protocols for establishing mutual authentication between agents at the beginning of a session and negotiation of cryptographic keys to use during the session. IPsec may protect data flows between a UE and an N3IWF, between a pair of hosts (host-to-host), between a pair of security gateways (network-to-network), or between a security gateway and a host (network-to-host). IPsec may employ cryptographic security services to protect communications over Internet Protocol (IP) networks. It may support network-level peer authentication, data-origin authentication, data integrity, data confidentiality (encryption), and replay protection. In an example, IPsec may be a layer 3 OSI model or internet layer end-to-end security scheme. In an example, IPsec may employ the following protocols to perform various functions: Authentication Headers (AH) as in FIG. 18A may provide connectionless data integrity and data origin authentication for IP datagrams and may provide protection against replay attacks. In an example, Encapsulating Security Payloads (ESP) as in FIG. 18B may provide confidentiality, connectionless data integrity, data-origin authentication, an anti-replay service (a form of partial sequence integrity), and limited traffic-flow confidentiality. Internet Security Association and Key Management Protocol (ISAKMP) may provide a framework for authentication and key exchange, with actual authenticated keying material provided either by manual configuration with pre-shared keys, Internet Key Exchange (IKE and IKEv2), Kerberized Internet Negotiation of Keys (KINK), or IPSECKEY DNS records. The purpose is to generate the Security Associations (SA) with the bundle of algorithms and parameters necessary for AH and/or ESP operations. In an example, AH header format may comprise Next Header (8 bits) (e.g., Type of the next header, indicating what upper-layer protocol was protected. The value may be taken from the list of IP protocol numbers), Payload Len (8 bits) (e.g., the length of this Authentication Header in 4-octet units, minus 2. For example, an AH value of 4 equals 3×(32-bit fixed-length AH fields)+3×(32-bit ICV fields)-2 and thus an AH value of 4 means 24 octets. Although the size is measured in 4-octet units, the length of this header needs to be a multiple of 8 octets if carried in an IPv6 packet. This restriction does not apply to an Authentication Header carried in an IPv4 packet), Reserved (16 bits) bits, Security Parameters Index SPI (32 bits) (e.g., an arbitrary value which is used (together with the destination IP address) to identify the security association of the receiving party), Sequence Number (32 bits) (e.g., a monotonic strictly increasing sequence number (incremented by 1 for every packet sent) to prevent replay attacks. When replay detection is enabled, sequence numbers are never reused, because a new security association must be renegotiated before an attempt to increment the sequence number beyond its maximum value), Integrity Check Value (multiple of 32 bits) (e.g., variable length check value. It may contain padding to align the field to an 8-octet boundary for IPv6, or a 4-octet boundary for IPv4).

In an example, ESP header format may comprise Security Parameters Index SPI (32 bits) (an arbitrary value used (together with the destination IP address) to identify the security association of the receiving party), Sequence Number (32 bits) (a monotonically increasing sequence number (incremented by 1 for every packet sent) to protect against replay attacks. There is a separate counter kept for every security association), Payload data (variable size)(e.g., the protected contents of the original IP packet, including any data used to protect the contents (e.g., an Initialization Vector for the cryptographic algorithm). The type of content that was protected is indicated by the Next Header field), padding (0-255 octets)(Padding for encryption, to extend the payload data to a size that fits the encryption's cipher block size, and to align the next field.), Pad Length (8 bits) (Size of the padding (in octets)), Next Header (8 bits) (e.g., type of the next header. The value is taken from the list of IP protocol numbers), and Integrity Check Value (multiple of 32 bits) (Variable length check value. It may contain padding to align the field to an 8-octet boundary for IPv6, or a 4-octet boundary for IPv4).

In an example, Generic Routing Encapsulation (GRE) may be employed for tunneling between the N3IWF and the UE. GRE is a tunneling protocol that may encapsulate a wide variety of network layer protocols inside virtual point-to-point links or point-to-multipoint links over an Internet Protocol (IP) network.

In an example embodiment as depicted in FIG. 18A and FIG. 18B, a UE may access network 1 via network 2. In an example, the UE may have two subscription e.g., one PLMN (aka “PLMN UE” for PLMN parts of the UE) and one SNPN (aka “SNPN UE” for SNPN parts of the UE) subscription. The scenarios described may employ PLMN and SNPN, but same principles may apply between SNPNs, if allowed.

In an example embodiment as depicted in FIG. 18A and FIG. 18B, the UE may be either in connected state or in a power saving state in the serving network (network 1) and still get service from the other network. The UE may be always in CM connected state in both networks and that the IPsec tunnel between the UE and N3IWF over Nwu may be always maintained. It may involve that the UE sends IPsec keep alive messages. In an example, in order for the UE to maintain an IPSec tunnel to network 1, a PDU session in network 1 may be required. As depicted in FIG. 18A and FIG. 18B, the UE may register to the network 2 (e.g., NPN). The UE may request service in order to setup an IPsec tunnel to the N3IWF. The service request may need to indicate the specific service (connection to the PLMN/network 2). The PDU session may be setup in network 2. The AMF may include in the RRC inactive assistance information that this UE may only be released to RRC Inactive and may send the RRC inactive assistance information to the RAN. This behavior in the AMF may be triggered by 1) either based on the UE indication in the NAS message (SR or PDU session establishment), or 2) informed by the SMF/UPF. The SMF/UPF, when the SMF/UPF detect that the target address for the IPSec tunnel is a known N3IWF of a PLMN (in this case the RRC Inactive Assistance IE may need to be updated if already sent). UE sets up the IPSec tunnel and registers to the PLMN (network 1). Due to inactivity in the network 1 (NPN) the RAN may release the UE to RRC Inactive mode. RAN may receive DL data or NAS message from the PLMN (network 1) to the UE. The RAN node may page the UE. The UE may resume the RRC-Connection. The DL data or NAS message may be sent to the UE.

In an example, FIG. 18A and FIG. 18B may depict an example registration and access procedure of a UE to the second network (network 2) in accordance with embodiments of the present disclosure. In an example, the UE may send a registration request message or a NAS message to the AMF via a base station of the second network. Upon completion of the registration procedure, the AMF may send a registration accept message to the UE that may comprise a support indication for IPSec with the first network, an underlying network capability support indication, one or more network IDs (e.g., SNPN ID). The one or more network IDs may indicate that the network may support underlying network capability for the one or more networks e.g., SNPN. The one or more network IDs may indicate that the network supports onboarding for the one or more networks. The registration accept message may comprise a CAG ID, S-NSSAI, and/or the like that may be employed for underlying network capability support, or IPSec tunnel to the second network. The UE may employ an element of the registration accept message to send a PDU session establishment request message. The PDU session establishment request message may comprise the CAG ID for underlying network access to the first network via the second network, the S-NSSAI for underlying network access to the first network via the second network, and/or the like. Upon establishment of the PDU session for underlying network access, the UE may establish or configure a connection, IPSec tunnel, and/or the like to an interworking function (N3IWF) of the first network. In an example, during the PDU session establishment procedure the SMF of the second network may select a UPF that can be connected to or have a logical/physical connectivity to the N3IWF of the first network. The SMF may select the UPF that may support underlying network capability.

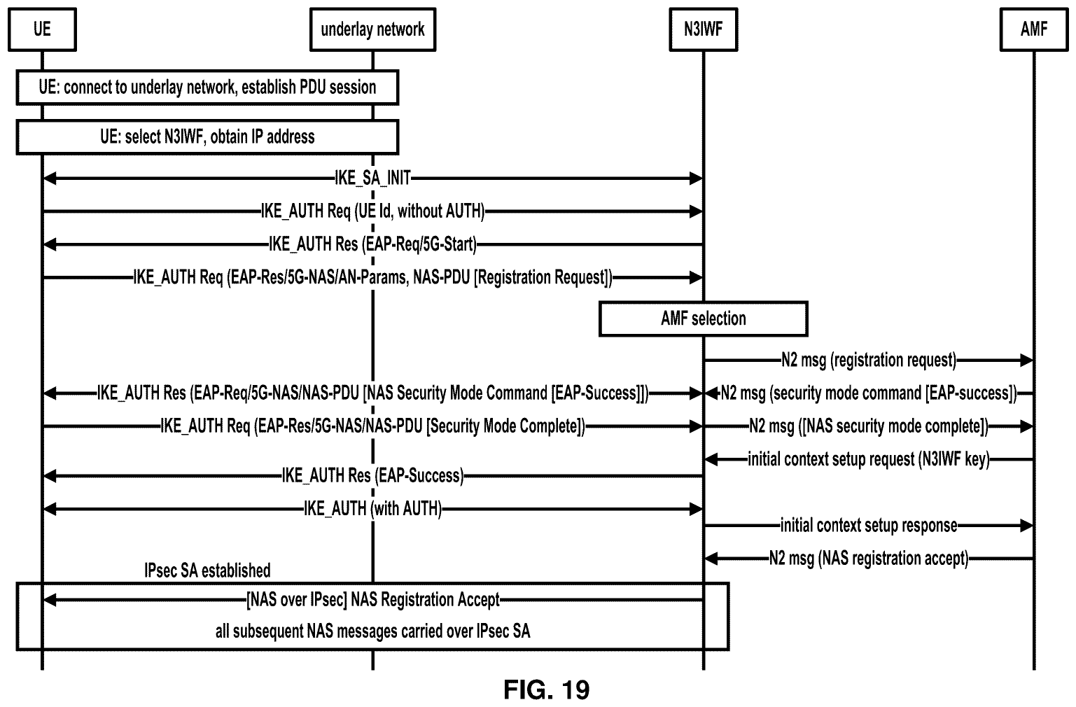

In an example as depicted in FIG. 19, the UE may connect to the underlay network using the registration procedure. The UE may establish a PDU session with the underlying network using the PDU session establishment procedure. In an example, to connect to an N3IWF of the overlay network, the UE may select an N3IWF.

In an example, the UE may the establish an IPsec Security Association (SA) with the selected N3IWF by initiating an IKE initial exchange. All subsequent IKE messages may be encrypted and integrity protected by using the IKE SA established. In an example, the UE may initiate an IKE_AUTH exchange by sending an IKE_AUTH request message. The AUTH payload may or may not be included in the IKE_AUTH request message, which may indicate that the IKE_AUTH exchange may use EAP signaling (for example, EAP-5G signaling). If the UE supports MOBIKE, it may include a notify payload in the IKE_AUTH request, indicating that MOBIKE is supported. In an example, if the UE is provisioned with the N3IWF root certificate, it may include the CERTREQ payload within the IKE_AUTH request message to request the N3IWF's certificate.

In an example, the N3IWF may respond with an IKE_AUTH response message, which may include an EAP-Request/5G-Start packet. The EAP-Request/5G-Start packet may inform the UE to initiate an EAP-5G session, e.g., to start sending NAS messages encapsulated within EAP-5G packets. If the N3IWF has received a CERTREQ payload from the UE, the N3IWF may include the CERT payload in the IKE_AUTH response message comprising the N3IWF's certificate.

In an example, the UE may send an IKE_AUTH request, which may comprise an EAP-Response/5G-NAS packet that may comprise the access network parameters (AN parameters) and a registration request message. The AN parameters may comprise information that is used by the N3IWF for selecting an AMF in the 5G core network (e.g., overlay network). This information may comprise e.g., the GUAMI, the selected PLMN ID (or PLMN ID and NID, SNPN ID, and/or the like), the requested NSSAI, the establishment cause, and/or the like. The establishment cause may provide the reason for requesting a signaling connection with 5GC.

In an example, the N3IWF may select an AMF based on the received AN parameters and local policy. The N3IWF may forward the registration request received from the UE to the selected AMF within an N2 message. The N2 message may comprise N2 parameters that include the selected PLMN ID and the establishment cause. The selected AMF may determine/decide to request the SUCI by sending a NAS identity request message to the UE. This NAS message and all subsequent NAS messages may be sent to the UE encapsulated within EAP/5G-NAS packets. In an example, the AMF may determine/decide to authenticate the UE by invoking an AUSF. The AMF may select an AUSF based on the SUPI or SUCI. In an example, the AUSF may execute the authentication of the UE. The AUSF may select a UDM and may get or receive the authentication data from the UDM. The authentication packets may be encapsulated within NAS authentication messages and the NAS authentication messages are encapsulated within EAP/5G-NAS packets. In an example, upon successful authentication: the AUSF may send the anchor key (SEAF key) to AMF which may be used by AMF to derive NAS security keys and a security key for N3IWF (N3IWF key). The UE may derive the anchor key (SEAF key) and from that key it derives the NAS security keys and the security key for N3IWF (N3IWF key). The N3IWF key may be used by the UE and N3IWF for establishing the IPsec Security Association. The AUSF may include the SUPI that the AMF provided to AUSF a SUCI.

In an example, the AMF may send a NAS security mode command to the UE in order to activate NAS security. If an EAP-AKA′ authentication was successfully executed, the AMF may encapsulate the EAP-Success received from AUSF within the NAS security mode command message. The N3IWF may forward the NAS security mode command message to the UE within an EAP/5G-NAS packet. The UE may complete the EAP-AKA′ authentication, create a NAS security context and an N3IWF key and may send the NAS security mode complete message within an EAP/5G-NAS packet. The N3IWF may relay/transmit the NAS security mode complete message to the AMF.

In an example, upon receiving NAS security mode complete, the AMF may send an NGAP initial context setup request message that includes the N3IWF key. This may trigger the N3IWF to send an EAP-Success to the UE, which completes the EAP-5G session.

In an example, the IPsec SA may be established between the UE and N3IWF by using the common N3IWF key that was created in the UE and received by the N3IWF. The established IPsec SA may be referred to as the signaling IPsec SA. After the establishment of the signaling IPsec SA, the N3IWF may notify the AMF that the UE context (including AN security) was created by sending a NGAP initial context setup response. The signaling IPsec SA may be configured to operate in tunnel mode and the N3IWF may assign to UE an inner IP address (a first IP address). If the N3IWF has received an indication that the UE supports MOBIKE, then the N3IWF may include a notify payload in the IKE_AUTH response message, indicating that MOBIKE may be supported.

In an example, all subsequent NAS messages exchanged between the UE and N3IWF may be sent via the signaling IPsec SA and may be carried over TCP/IP or the like. The UE may send NAS messages within TCP/IP packets with source address the inner IP address of the UE and destination address the NAS_IP_ADDRESS. The N3IWF may send NAS messages within TCP/IP packets with source address the NAS_IP_ADDRESS and destination address the inner IP address of the UE. The TCP connection used for reliable NAS transport between the UE and N3IWF may be initiated by the UE after the signaling IPsec SA is established. The UE may send the TCP connection request to the NAS_IP_ADDRESS and to the TCP port number.

In an example, the AMF may send the NAS registration accept message to the N3IWF. The N2 Message may comprise the Allowed NSSAI for the access type for the UE. The N3IWF may send or forward the NAS registration accept to the UE via the established signaling IPsec SA. If the NAS registration request message is received by the N3IWF before the IPsec SA is established, the N3IWF may store it and forward it to the UE only after the establishment of the signaling IPsec SA. In an example, the AMF may provide the access type set to non-3GPP access to the UDM when it registers with the UDM. In an example, the AMF may provide the access type set to underlay network access, IPSec tunnel access, the underlay or underlying network 3GPP access, and/or the like to the UDM when it registers with the UDM. In an example embodiment, the access type may be set to non-3GPP access over 3GPP access.

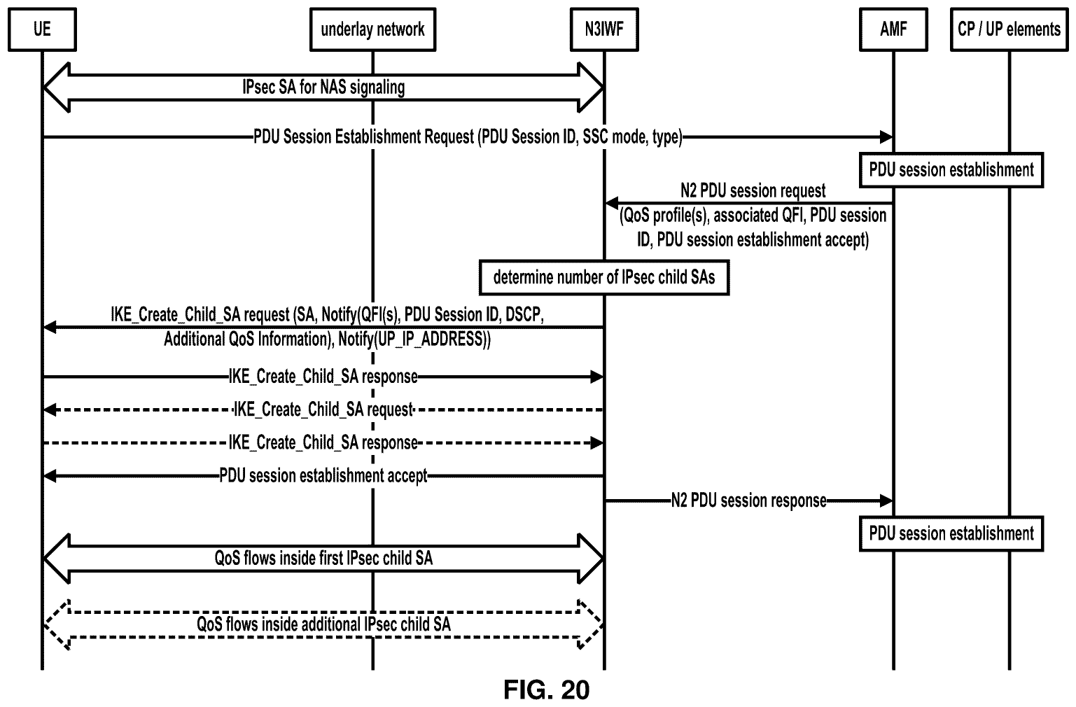

In an example embodiment as depicted in FIG. 20, the UE may send a PDU session establishment request message to the AMF of the overlay network via the N3IWF. The PDU session establishment request message may be sent to the N3IWF via the IPsec SA for NAS signaling and the N3IWF may transparently forward/send it to the AMF in the 5GC (e.g., the overlay network). In an example, the AMF may send a N2 PDU session request message to N3IWF to establish the access resources for this PDU Session. Based on its own policies and configuration, and based on the QoS profiles received, the N3IWF may determine the number of IPsec Child SAs to establish and the QoS profiles associated with each IPsec Child SA. For example, the N3IWF may decide/determine to establish one IPsec Child SA and associate all QoS profiles with this IPsec Child SA. In this case, all QoS Flows of the PDU Session may be transferred over one IPsec Child SA. The N3IWF may send to the UE an IKE Create_Child_SA request to establish the first IPsec Child SA for the PDU Session. In an example, the IKE Create_Child_SA request may be an IPsec create child SA request. The IKE Create_Child_SA request indicates that the requested IPsec Child SA may operate in tunnel mode. This request may include a 3GPP-specific notify payload which contains (a) the QFI(s) associated with the Child SA, (b) the identity of the PDU session associated with this Child SA, (c) a DSCP value associated with the Child SA, (d) a Default Child SA indication, and (e) the additional QoS Information, and/or the like. The IKE Create_Child_SA request may comprise another 3GPP-specific notify payload, which contains a UP_IP_ADDRESS. If a DSCP value is included, then the UE and the N3IWF may mark all IP packets sent over this Child SA with this DSCP value. There may be one default child SA per PDU session. The UE may send all QoS flows to this Child SA for which there is no mapping information to a specific Child SA. The IKE Create_Child_SA request may comprise other information such as the SA payload, the traffic selectors (TS) for the N3IWF and the UE. After receiving the IKE Create_Child_SA request, if the Additional QoS Information is received, the UE may reserve non-3GPP access network resources according to the additional QoS information.

In an example, if the UE accepts the new IPsec Child SA, the UE may send an IKE Create_Child_SA response. During the IPsec Child SA establishment the UE may or may not be assigned an IP address. If the N3IWF determined to establish multiple IPsec Child SAs for the PDU session, then additional IPsec Child SAs may be established, additional IPsec Child SAs may be associated with one or more QFI(s), with a DSCP value, with a UP_IP_ADDRESS and with the Additional QoS Information. For IPsec Child SA, if the additional QoS information is received, the UE may reserve non-3GPP access network resources according to the additional QoS information for the IPsec Child SA.

In an example, after IPsec Child SAs are established, the N3IWF may forward to UE via the signaling IPsec SA the PDU session establishment accept message. The N3IWF may send to the AMF an N2 PDU session response.

In an example, on the user-plane, when the UE has to transmit an UL PDU, the UE may determine the QFI associated with the UL PDU (by using the QoS rules of the PDU Session), it may encapsulate the UL PDU inside a GRE packet and may forward the GRE packet to N3IWF via the IPsec Child SA associated with this QFI. The header of the GRE packet carries the QFI associated with the UL PDU. The UE may encapsulate the GRE packet into an IP packet with source address the inner IP address of the UE and destination address the UP_IP_ADDRESS associated with the Child SA.

In an example, when the N3IWF receives a DL PDU via N3, the N3IWF may use the QFI and the identity of the PDU session in order to determine the IPsec Child SA to use for sending the DL PDU over NWu. The N3IWF may encapsulate the DL PDU inside a GRE packet and copies the QFI in the header of the GRE packet. The N3IWF may include in the GRE header a Reflective QoS Indicator (RQI), which may be used by the UE to enable reflective QoS. The N3IWF may encapsulate the GRE packet into an IP packet with source address the UP_IP_ADDRESS associated with the Child SA and destination address the inner IP address of the UE.

In an example embodiment, an extended access type, an auxiliary access type, an underlay network access type, an intermediate access type, and/or the like, may refer to an access type wherein the UE may access a network (e.g., an overlay network) via an access network and user plane connection of another network (referred to as an underlay network). The extended access type may be associated or be employed to establish a first PDU session of the UE in the overlay network. The user plane connection of the UE in the underlay network may be provided by a second PDU session of the UE in the underlay network. The second PDU session may be employed to establish an IPsec connectivity between the UE and the N3IWF of the overlay network. In an example, access of the UE to the N3IWF of the overlay network via the user plane resources of the underlay network may be referred to as the extended access type. For example, the UE may access the overlay network via 3GPP access or via non-3GPP access. In an example the UE may access the underlay network via the 3GPP access in order to access an overlay network via the N3IWF of the overlay network. In an example the UE may access a network via the non-3GPP access of the underlay network in order to access an overlay network via non-3GPP interworking function of the overlay network. From the overlay network perspective, such access may be referred to as extended access type (or the auxiliary access type, underlay network access type, intermediate access type, and/or the like). In an example, the extended access type may be a third access type such as underlay access, non-3GPP access over (via) 3GPP access, IPsec access over 3GPP access, and/or the like. In an example, an extended access type indication may be an indication that an overlay network may be accessed via an underlay network. The extended access type indication may comprise an indication that the UE may employ configuration parameters from at least one of the first network (overlay network) and the second network (underlay network). The configuration parameters may comprise UE route selection policy URSP, TAI, registration area, the mobility restrictions, and/or the like.

In an example embodiment, access of the UE to the overlay network may be restricted based on location of the UE, the UE being in an area of interests, or outside the area of interest, and/or the like. In an example embodiment, a rejection cause may be sent by the network to the UE. The rejection cause may comprise an indication that N1 mode is not allowed for N3GPP access type, N1 mode is not allowed for the extended access type, and/or the like. The rejection cause may comprise an indication that N1 mode is not allowed for underlay access type (or extended access type) of the UE within a location. The N1 mode is not allowed indication may indicate that access of the UE to the network via N3GPP, 3GPP, or extended access type may not be permitted based on subscription, location restrictions (e.g., location of the UE) or operator policy. In an example, the N1 mode not allowed indication may be an access rejection indication that may be based on an AN parameter, user location information (ULI), a cell ID that the UE is connected to, access type, radio access type (RAT type), access restrictions, the mobility restrictions, and/or the like. In an example, when EPC and E-UTRA is used, S1 mode capability may be employed. In an example, the error or rejection cause may indicate S1 mode not allowed. The MME may send to the RAN node and to the UE a NAS message indicating that S1 mode is not allowed for the access type or the RAT type.

In an example, FIG. 16 and FIG. 17 may depict an example wherein a UE may send access request to an underlay network. The access request may comprise an indication that the UE may access the underlay network to establish a connection for accessing an overlay network. In an example, the access restrictions may be determined (by the overlay network and/or the underlay network) based on location information of the wireless device. In an example, access restrictions may apply to the UE. The access restrictions may be determined by the underlay network based on the subscription of the UE in the underlay network and/or the overlay network. The access restrictions may be determined by the overlay network based on the subscription of the UE in the overlay network. In an example, access restrictions may comprise the mobility restrictions. In an example, the mobility restrictions may comprise RAT restriction, forbidden area, service area restrictions, core network type restriction and closed access group information, and/or the like.

In an example embodiment as depicted in FIG. 16 and FIG. 17, the access restrictions may be configured by the overlay network, or underlay network and may be implemented (applied, imposed, enforced) by the UE, or an entity (such as RAN node, an N3IWF, or a core network entity) of the overlay network or of the underlay network.

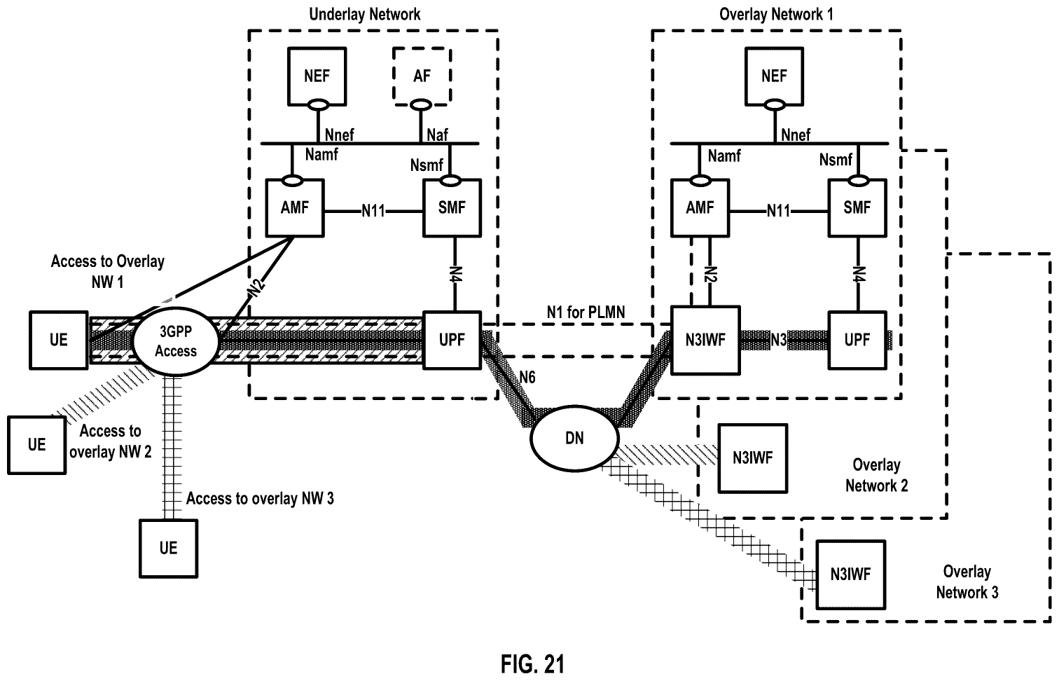

A wireless device (UE) may determine to establish a first PDU session with an overlay network. As depicted in FIG. 21, the UE may access the overlay network (e.g., a PLMN, or SNPN) via an underlay network (e.g., a PLMN or SNPN). The UE may access the overlay network via a 3GPP access (e.g., a RAN node). The UE may register with the underlay network, then establish a second PDU session with the underlay network. The UE may employ the second PDU session to establish IPsec connectivity with an N3IWF of the overlay network. The UE may employ the IPsec connection to register with the overlay network and establish the first PDU session with the overlay network.

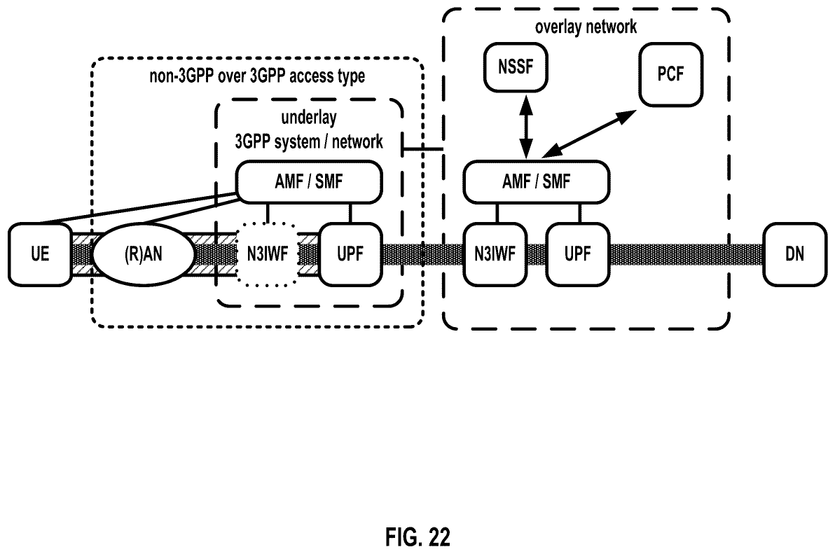

In an example embodiment as depicted in FIG. 22, existing technologies may support association of policy during a procedure of accessing the UE to the network. The procedure may be the registration procedure, the PDU session establishment procedure, PDU session modification procedure, the service request procedure, and/or the like. In an example, during the procedure, a policy association procedure may be performed between the AMF and PCF or between the SMF and the PCF. In an example, during the policy association procedure, the AMF may provide allowed NSSAIs to the PCF based on the access type of the UE. The AMF may provide allowed NSSAIs based on local configuration or retrieve from NSSF. In an example, based on the existing technologies, when a UE is accessing the overlay network via the underlay network, the AMF may determine allowed NSSAIs or allowed S-NSSAIs based on the non-3GPP access type. If allowed NSSAIs for N3GPP access is retrieved and provided to the PCF, erroneous policy information may be provided by the PCF. In addition, policy information provided by the PCF such as supported features may not correspond to the requirements of the UE when accessing via underlay network. The response from the PCF may be based on UE access to the network via N3GPP. In an example, access of the UE to the network may be rejected with no cause by the overlay network. In an example, the overlay network may determine an action based on wrong information and may accept registration. When registration is accepted, the UE may not successfully establish a user plane connection with the overlay network.

As depicted in FIG. 22, example embodiments improve system performance by signaling enhancements between the AMF, SMF, NSSF and PCF to determine proper network slice configuration in order to perform successful policy association procedure.

In an example, the PCF may determine a policy based on allowed S-NSSAIs. The PCF may employ one or more pieces of information such as network operator's policies, user subscription, user's current RAT, network load status, application identifier, time of day, UE location, DNN, related to the subscriber session and the application traffic as input for selecting the policy. In an example, the policy may comprise maximum bit rate (MBR) allowed for the UE based on network slice configuration. For example, when a feature such as UE-Slice-MBR_Authorization is supported and the PCF received the ueSliceMbrs attribute in a request, the authorized UE-Slice-MBR(s) for the allowed NSSAI may be encoded as ueSliceMbrs attribute. In an example, the policy may be traffic steering policy, data rate related policy, charging policy, and/or the like. In an example, the PCF may control traffic steering by provisioning and modifying traffic steering control information in PCC rules. Traffic steering control information consists of a traffic description and a reference to a traffic steering policy that may be configured in the SMF. In an example, policy information may comprise UE route selection policy (URSP) that may be determined by the PCF. In an example, the URSP may comprise a route selection descriptor (RSD) parameter. In an example, the URSP may comprise an element that may indicate what S-NSSAIs may be employed for a PDU session of the wireless device. In an example, the RSD may comprise a network slice criteria, a location criteria, and/or the like. In an example, the PCF may configure the UE via the URSP and then RSD to select proper parameters such as S-NSSAI, DNN, and/or the like based on the RSD. In an example, policy and charging control may comprise provision of policy and charging control information by the PCF to the AMF, or to the UE. In an example, policy and charging control information may comprise allowed network slices such as S-NSSAIs, allowed DNNs, maximum bit rate that is allowed for a PDU session of the UE, whether the UE is allowed to establish a local area data network (LADN) PDU session, and/or the like. In an example, if the PCF does not provide the proper policy information or the policy information is based on a wrong or inaccurate set of allowed SNSSAIs or slice information, the UE may perform a request to establish a PDU session and the PDU session may be rejected due to unauthorized network slice request, not allowed to establish a LADN PDU session, and/or the like.

In an example, the AMF may select a SMF during an access procedure of a UE. The SMF selection may be based on the network slice e.g., NSSAI, S-NSSAIs, and/or the like. The AMF may determine allowed NSSAIs or allowed slices based on the access type of the UE being the underlay access type. If the AMF sends a query to the NSSF to determine allowed network slices for the N3GPP access type, then the AMF may use the allowed NSSAIs based on the N3GPP access type instead of underlay access type to select an SMF for access the UE. When a wrong SMF is selected during a procedure, the SMF may subsequently not support required features and may configure the user plane in a way not intended or not aligned with the requirements of the UE when accessing via the underlay network.

In an example embodiment, access and mobility policy control service, may be provided by the policy control function (PCF) (e.g., policy and charging control function). This service provides access control and mobility management related policies to the NF service consumer and offers the following functionalities: policy creation based on a request from a network function (NF) service consumer during UE registration, notification of the NF service consumer of the updated policies which are subscribed, deletion of the policy context for a UE. In an example, the PCF may support unified policy framework to govern network behavior. In an example, the PCF may provide access and mobility management related policies to the NF service consumer that enforces them. In roaming scenario, the Visited Policy Control Function (V-PCF) may provide the functions described for the PCF in the visited network. In an example, the NF Service Consumers may comprise a core network function node such as AMF, SMF, UDM, and/or the like. The access and mobility management function (AMF) may provide: Registration management; Connection management; Reachability management; Mobility Management, and/or the like. In an example, the following service operations may be employed by NFs to interact with the PCF.

| Service operation name | Description | Initiated by |
|---|---|---|
| Npcf_AMPolicyControl_Create | Creates an AM Policy Association and | NF service |
| | provides corresponding policies to the NF | consumer |
| | service consumer. | (e.g. AMF) |
| Npcf_AMPolicyControl_Update | Updates an AM Policy Association and | NF service |
| | provides corresponding policies to the NF | consumer |
| | service consumer when a policy control | (e.g. AMF) |
| | request trigger is met or the AMF is relocated | |
| | due to UE mobility and the old PCF is | |
| | selected. | |
| Npcf_AMPolicyControl_UpdateNotify | Provides updated policies to the NF service | PCF (V-PCF in |
| | consumer. | roaming case) |
| Npcf_AMPolicyControl_Delete | Provides means for the NF service consumer | NF service |
| | to delete the AM Policy Association. | consumer |
| | | (e.g. AMF) |

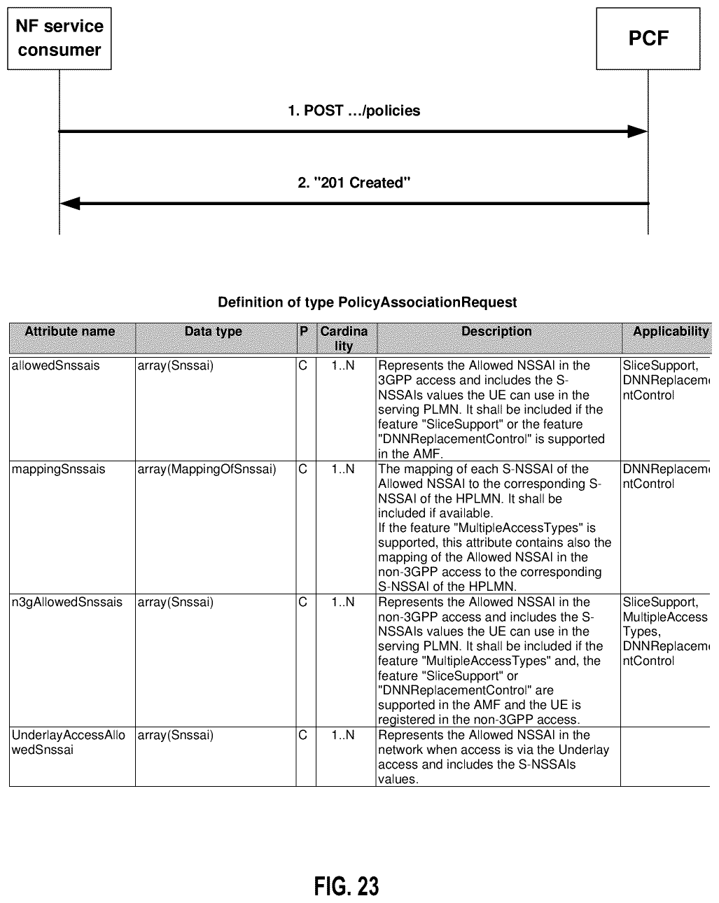

In an example as depicted in FIG. 23, the interaction between the NF and the PCF may comprise Npcf_AMPolicyControl_Create Service Operation and may be employed to create an AM policy association when the UE registers to the network, and when the AMF is relocated (between the different AMF sets) and the new AMF selects a new PCF.

In an example, when a UE registers and a UE context is being established, the AMF may obtain service area restrictions, RESP index, subscribed UE-AMBR, subscribed UE-Slice-MBR(s) and GPSI(s) from the UDM during the Access and Mobility Subscription Data retrieval procedure and the allowed NSSAI from local configuration or from the NSSF during the slice selection procedure and may decide based on local policies whether to request policies from the PCF. To request policies from the PCF, the NF service consumer (e.g. AMF) may send an HTTP POST request with: “{apiRoot}/npcf-am-policy-control/v1/policies” as Resource URI and the PolicyAssociationRequest data structure as request body that may include: Notification URI encoded as “notificationUri” attribute, SUPI encoded as “supi” attribute, if the feature “SliceSupport” or the feature “DNNReplacementControl” is supported in the NF service consumer and the UE is registered via a 3GPP access, the allowed NSSAI in the 3GPP access encoded in the “allowedSnssais” attribute, and/or the like.

In an example, the HTTP POST request may comprise: GPSI encoded as “gpsi” attribute; if the feature “MultipleAccessTypes” is not supported, the access type encoded as “accessType” attribute; Permanent Equipment Identifier (PEI) encoded as “pei” attribute; User Location Information encoded as “userLoc” attribute; UE Time Zone encoded as “timeZone” attribute; Serving PLMN Identifier and for SNPN the NID encoded as “servingPlmn” attribute; if the feature “MultipleAccess Types” is not supported, the RAT type encoded as “ratType” attribute; Service Area Restrictions derived from the Service Area Restrictions obtained from the UDM by mapping any service areas denoted by geographical information into Tracking Area Identities (TAIs) and encoded as “servAreaRes” attribute; RFSP index as obtained from the UDM encoded as “rfsp” attribute; A list of Internal Group Identifiers encoded as “groupIds” attribute; if the NF service consumer is an AMF, the GUAMI encoded as “guami” attribute; if the NF service consumer is an AMF, the name of a service produced by the AMF that expects to receive information within Npcf_AMPolicyControl_UpdateNotify service operation encoded as “serviceName” attribute; Alternate or backup IPv4 Address(es) where to send Notifications encoded as “altNotifIpv4Addrs” attribute; Alternate or backup IPv6 Address(es) where to send Notifications encoded as “altNotifIpv6Addrs” attribute; Alternate or backup FQDN(s) where to send Notifications encoded as “altNotifFqdns” attribute; trace control and configuration parameters information encoded as “traceReq” attribute; if the feature “UE-AMBR_Authorization” is supported in the NF service consumer, the subscribed UE-AMBR in the “ueAmbr” attribute; if the feature “DNNReplacementControl” is supported, the mapping of each S-NSSAI of the Allowed NSSAI to the corresponding S-NSSAI of the HPLMN encoded in the “mappingSnssais” attribute; and if the feature “UE-Slice-MBR_Authorization” is supported in the AMF, the subscribed UE-Slice-MBR(s) for the allowed NSSAI in the “ueSliceMbrs” attribute.

In an example, upon the reception of this HTTP POST request, the PCF may: assign a policy association ID (The assigned policy association ID may be part of the URI for the created resource and is thus associated with the SUPI); determine the applicable policy (taking into consideration and optionally modifying the possibly received UE-AMBR, UE-Slice-MBR(s), Service Area Restrictions and/or RFSP index); for the successful case, send a HTTP “201 Created” response with the URI for the created resource in the “Location” header field and the PolicyAssociation data type as response body including: conditionally AMF Access and Mobility Policy e.g.:
a) if the PCF received the “servAreaRes” attribute in the request, Service Area Restrictions encoded as “servAreaRes” attribute; and/or
b) if the PCF received the “rfsp” attribute in the request, RAT Frequency Selection Priority (RFSP) Index encoded as “rfsp” attribute; and/or
c) if the feature “UE-AMBR_Authorization” is supported and the PCF received the “ueAmbr” attribute in the request, the authorized UE-AMBR encoded as “ueAmbr” attribute; and/or
d) if the feature “UE-Slice-MBR_Authorization” is supported and the PCF received the “ueSliceMbrs” attribute in the request, the authorized UE-Slice-MBR(s) for the allowed NSSAI encoded as “ueSliceMbrs” attribute; optionally one or several of the following Policy Control Request Trigger(s) encoded as “triggers” attribute:
a) Location change (tracking area); and
b) Change of UE presence in PRA; and
c) if the “SliceSupport” feature or the “DNNReplacementControl” feature is supported, change of allowed NSSAI; and
d) if the “DNNReplacementControl” feature is supported, change of SMF selection information; and if the Policy Control Request Trigger “Change of UE presence in PRA” is provided, the presence reporting areas for which reporting is required encoded as “pras” attribute;

If the PCF uses a Presence Reporting Area identifier referring to a Set of Core Network predefined Presence Reporting Areas, the PCF includes the identifier of this Presence Reporting Area set within the “praId” attribute. if the Policy Control Request Trigger “Change of SMF selection information” is provided, the SMF selection information representing the conditions upon which the AMF shall request a DNN replacement encoded as “smfSelInfo” attribute; if errors occur when processing the HTTP POST request, apply error handling procedures and according to the following provisions: if the user information received within the “supi” attribute is unknown, the PCF shall reject the request and include in an HTTP “400 Bad Request” response message the “cause” attribute of the ProblemDetails data structure set to “USER_UNKNOWN”; if the PCF is, due to incomplete, erroneous or missing information in the request, not able to provision an AM policy decision, the PCF may reject the request and include in an HTTP “400 Bad Request” response message the “cause” attribute of the ProblemDetails data structure set to “ERROR_REQUEST_PARAMETERS”. If the PCF rejects the AM policy association establishment, the NF service consumer shall apply the policy retrieved from the UDM if available; otherwise, the NF service consumer shall apply the operator configured policy.

In an example, slice information e.g., NSSAI, S-NSSAI, and/or the like may be employed by SMF selection management procedures. If the “DNNReplacementControl” feature is supported, when SMF selection management is enabled, the SMF selection information may be encoded using the “SmfSelectionData” data type, which may comprise: the conditions upon which the AMF shall request to the PCF the replacement of SMF selection data, which may include:
a) an indication of whether the AMF shall request DNN replacement when the UE requested an unsupported DNN during PDU session establishment encoded in the “unsuppDnn” attribute; and/or
b) a list of candidate DNNs for replacement encoded in the “candidates” map, where:
i) the key of the map is the S-NSSAI; and
ii) each entry of the map is of “CandidateForReplacement” data type, which: may include the S-NSSAI encoded in the “snssai” attribute; and may include the list of candidate DNNs for the S-NSSAI encoded in the “dnns” attribute;

In an example, the S-NSSAIs included in the map are S-NSSAIs of the allowed NSSAI valid in the serving network. The PCF may store/keep updated information of the allowed NSSAI valid in the serving network by subscribing to the policy control request trigger Change of allowed NSSAI of the served UE.

In an example, the SMF selection information may be encoded using the “SmfSelectionData” data type, which may comprise:
a) when included within the Npcf_AMPolicyControl_Update request, the UE requested DNN and S-NSSAI at PDU session establishment that matched an entry of the “candidates” map, encoded in the “dnn” attribute and in the “snssai” attribute respectively, and the mapping to the home S-NSSAI encoded in the “mappingSnssai” attribute if available; and
b) when included within the Npcf_AMPolicyControl_Update response, the PCF selected DNN encoded in the “dnn” attribute;

In an example, the PCF may select the same DNN and S-NSSAI as the UE requested DNN and S-NSSAI. When the PCF returns an unsupported DNN, the AMF may apply internal policies to reject the PDU session establishment.

When the “dnns” attribute is omitted in an entry of the “candidates” map it represents that the AMF may invoke the procedure for any UE request matching the S-NSSAI value included in the “snssai” attribute.

In an example UE slice maximum bit rate (e.g., the UE-Slice-MBR) may limit the aggregate bit rate that can be expected to be provided across all GBR and Non-GBR QoS Flows of a UE for an S-NSSAI.

In an example embodiment the NF may send to the PCF a policy association request. The policy association request may comprise: notificationUri, altNotifIpv4Addrs, altNotifIpv6Addrs, altNotifFqdns, supi, gpsi, accessType, accessTypes, pei, userLoc, timeZone, servingPlmn, ratType, ratTypes, groupIds, servAreaRes, wlServAreaRes, rfsp, ueAmbr, ueSliceMbrs, allowedSnssais, mappingSnssais, n3gAllowedSnssais, guami, serviceName, suppFeat, traceReq, and/or the like. In an example, the allowedSnssais may represent the Allowed NSSAI in the 3GPP access and includes the S-NSSAIs values the UE can use in the serving PLMN or NPN or SNPN. It may be included if the feature “SliceSupport” or the feature “DNNReplacementControl” is supported in the AMF. In an example, the mapping of each S-NSSAI of the Allowed NSSAI to the corresponding S-NSSAI of the HPLMN, PLMN, NPN, SNPN, HSNPN (home SNPN), and/or the like. If the feature “MultipleAccessTypes” is supported, this attribute also contains the mapping of the Allowed NSSAI in the non-3GPP access or underlay access to the corresponding S-NSSAI of the HPLMN, PLMN, NPN, SNPN, and/or the like. In an example, the n3gAllowedSnssais may represent the Allowed NSSAI in the non-3GPP access and includes the S-NSSAIs values the UE can use in the serving PLMN. It shall be included if the feature “MultipleAccess Types” and, the feature “SliceSupport” or “DNNReplacementControl” are supported in the AMF and the UE is registered in the non-3GPP access.

In an example, the policy association request may comprise an underlay access allowed slice information element IE (underlay access allowed slice IE). In an example the underlay access allowed slice IE may comprise a field such as underlayAccessAllowedSnssais indicating allowed S-NSSAIs or allowed network slices for access of the UE via underlay access type e.g., non-3GPP access over 3GPP access, or the like. In an example, the underlayAccessAllowedSnssais may be the underlay access allowed slice IE. In an example, the underlayAccessAllowedSnssais may represents the Allowed NSSAI in the underlay access and includes the S-NSSAIs values the UE can use in the serving network e.g., SNPN or PLMN, or in an overlay network, or in an underlay network. It may be included if the feature “MultipleAccessTypes” and, the feature “SliceSupport” or “DNNReplacementControl” are supported in the AMF and the UE is registered in the non-3GPP access or 3GPP access of the underlay network and accessing the overlay network via the network.

In an example embodiment, the underlay access allowed slice IE (the underlayAccessAllowedSnssais) may comprise an allowed NSSAI for this PLMN (e.g., network, SNPN, NPN, and/or the like) and access type. In an example, the PLMN may be the overlay network. In an example, the PLMN may be the underlay network. In an example, the underlay access allowed slice may be based on an identifier of the underlay network via which the UE may access the overlay network.

In an example embodiment, the UE may send an access request to the overlay network. In an example, the UE may send an access request to the underlay network. In an example, the access request may be a registration request message, a service request message, an IPsec message to the N3IWF, a PDU session establishment request message, and/or the like.

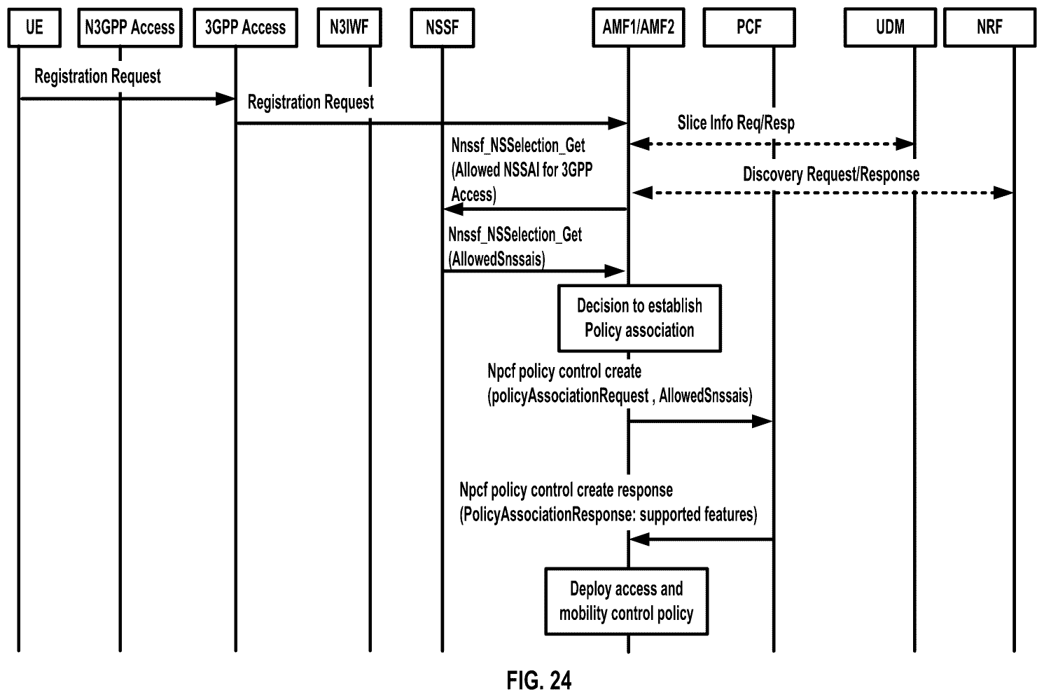

FIG. 24 may depict an example access request procedure in a network in accordance with embodiments of the present disclosure. The UE may send to a base station, or a 3GPP access e.g., 3GPP RAN node a registration request message, an access request message, an AN message, and/or the like. The AN message may comprise (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behavior], [UE paging probability information], [UE Policy Container (the list of PSIs, indication of UE support for ANDSP and the operating system identifier)] and [UE Radio Capability ID], [Release Request indication], [Paging Restriction Information], PEI, [Network Slice Simultaneous Registration Group (NSSRG) handling support indication], [PLMN with Disaster Condition])).

In an example, the base station may send to the AMF an N2 message (e.g., comprising N2 parameters, Registration Request, [LTE-M Indication], and/or the like. When NG-RAN is used, the N2 parameters may comprise the Selected PLMN ID (or PLMN ID and NID, and/or the like), Location Information and Cell Identity related to the cell in which the UE is camping, UE Context Request which indicates that a UE context including security information needs to be setup at the NG-RAN.

In an example embodiment, the base station (e.g., RAN) may send the Registration request message within an Initial UE message to the initial AMF (e.g., AMF 1). If the initial AMF needs UE's subscription information to decide whether to reroute the Registration Request and UE's slice selection subscription information was not provided by old AMF, the AMF selects a UDM. Initial AMF may send to UDM a message such as Nudm_SDM_Get (an access type indication, SUPI, Slice Selection Subscription data). In an example, the access type indication may comprise 3GPP access type (or underlay access type indication, the identifier of the underlay network if the UE is accessing the network via an underlay network, and/or the like. The initial AMF may request UE's Slice Selection Subscription data from UDM by invoking the Nudm_SDM_Get service operation. UDM may get this information from UDR by Nudr_DM_Query (SUPI, Slice Selection Subscription data). The UDM may send to initial AMF: Response to Nudm_SDM_Get. The AMF gets the Slice Selection Subscription data including Subscribed S-NSSAIs. In an example, the UDM may respond with slice selection data to initial AMF. The Initial AMF may send to a NSSF: Nnssf_NSSelection_Get (the access type indication (e.g., for underlay access type, the identifier of the underlay network, and/or the like), Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI). If there is a need for slice selection, e.g., the initial AMF cannot serve all the S-NSSAI(s) from the Requested NSSAI permitted by the subscription information, or for the underlay access type, the initial AMF may invoke the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the Network Slice Simultaneous Registration Group (NSSRG) Information for the S-NSSAIs of the network, including information whether the UE has indicated support of the subscription-based restrictions to simultaneous registration of network slices, and whether the UDM has indicated to provide all subscribed S-NSSAIs for non-supporting UEs.

In an example, the NSSF may send to the AMF a response to Nnssf_NSSelection_Get (AMF Set or list of AMF addresses, Allowed NSSAI for the 3GPP access type, [Mapping Of Allowed NSSAI for the 3GPP access type], Allowed NSSAI for the N3GPP access type, [Mapping Of Allowed NSSAI for the N3GPP access type], Allowed NSSAI for the underlay access type, [Mapping Of Allowed NSSAI for the underlay access type], Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s))], [Configured NSSAI for the Serving PLMN, SNPN, NPN, the network, the overlay network, the underlay network, and/or the like], [Mapping Of Configured NSSAI]).

The NSSF may return to the AMF allowed NSSAI for the underlay access type, [Mapping of Allowed NSSAI for the underlay access type], the Allowed NSSAI for the first access type, optionally the Mapping of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s) that may be employed for access of the UE via underlay access. It may also return information regarding rejection causes for S-NSSAI(s) not included in the Allowed NSSAI. The NSSF may return Configured NSSAI for the Serving PLMN (e.g., network), and the associated mapping of the Configured NSSAI. If the NSSRG information was included in the request, the NSSF provides the Configured NSSAI.

In an example embodiment, the AMF may perform an AM policy association establishment/modification. If the AMF selects a new (V-)PCF, the AMF may perform AM Policy Association Establishment with the selected (V-)PCF. If the (V-)PCF identified by the (V-)PCF ID included in UE context from the old AMF is used, the new AMF performs AM Policy Association Modification with the (V-)PCF. If the AMF notifies the Mobility Restrictions (e.g. UE location) to the PCF for adjustment, or if the PCF updates the Mobility Restrictions itself due to some conditions (e.g., application in use, time and date), the PCF may provide the updated Mobility Restrictions to the AMF. If the subscription information includes Tracing Requirements, the AMF may provide the PCF with Tracing Requirements. If the AMF supports DNN replacement, the AMF may provide the PCF with the Allowed NSSAI and, if available, the Mapping of Allowed NSSAI. If the PCF supports DNN replacement, the PCF provides the AMF with triggers for DNN replacement.

In an example embodiment, based on local policies, the AMF may determine or may decide to establish AM Policy Association with the PCF. If the AMF has not yet obtained Access and Mobility policy for the UE or if the Access and Mobility policy in the AMF are no longer valid, the AMF requests the PCF to apply operator policies for the UE from the PCF. The AMF sends Npcf_AMPolicyControl_Create to the PCF or (V-)PCF to establish an AM policy control association with the PCF. The request may comprise the following information: policy association request, allowed S-NSSAIs, SUPI, Internal Group, subscription notification indication and, if available, Service Area Restrictions, RFSP index, Subscribed UE-AMBR, List of Subscribed UE-Slice-MBR, the Allowed NSSAI, Target NSSAI, GPSI which are retrieved from the UDM during the update location procedure, and may include Access Type and RAT Type, PEI, ULI, UE time zone, and Serving Network (PLMN ID, or PLMN ID and NID, and/or the like).

In an example embodiment, when AMF utilizes an NWDAF, it may add the NWDAF serving the UE identified by the NWDAF instance ID. Per NWDAF service instance the Analytics ID(s) are also included. The PCF may respond to the Npcf_AMPolicyControl_Create service operation. The PCF may provide Access and mobility related policy information (e.g. Service Area Restrictions). In an example, the PCF may provide Policy Control Request Trigger of AM Policy Association to AMF. In the non-roaming case, the PCF may subscribe to Analytics from NWDAF. The PCF may register to the BSF as the PCF that handles the AM Policy Association for this UE. This is performed by using the Nbsf_Management_Register operation, providing as inputs the UE SUPI/GPSI and the PCF identity. The AMF deploys the Access and mobility related policy information which includes storing the Service Area Restrictions and Policy Control Request Trigger of AM Policy Association, provisioning Service Area Restrictions to the UE and provisioning the RFSP index, the UE-AMBR, List of UE-Slice-MBR, Service Area Restrictions to the NG-RAN and request for notification of SM Policy association establishment and termination to a list of (DNN, S-NSSAI)(s) together with PCF for the UE binding information.

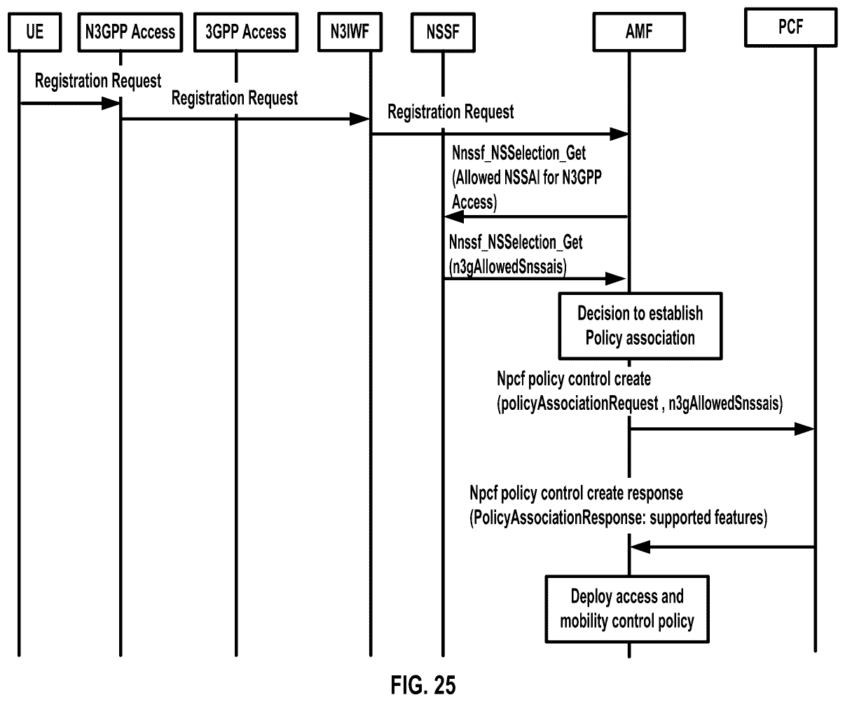

FIG. 25 may depict an example access request procedure of the UE via Non-3GPP (N3GPP) access type in a network in accordance with embodiments of the present disclosure. The UE may send to an N3IWF node a registration request message, an access request message, an AN message, and/or the like. The AN message may comprise (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behavior], [UE paging probability information], [UE Policy Container (the list of PSIs, indication of UE support for ANDSP and the operating system identifier)] and [UE Radio Capability ID], [Release Request indication], [Paging Restriction Information], PEI, [Network Slice Simultaneous Registration Group (NSSRG) handling support indication], [PLMN with Disaster Condition])).

In an example, the N3IWF may send to the AMF an N2 message (e.g., comprising N2 parameters, registration request , and/or the like. In an example embodiment, the N3IWF may send the registration request message within an Initial UE message to the initial AMF (e.g., AMF 1). If the initial AMF needs UE's subscription information to decide whether to reroute the Registration Request and UE's slice selection subscription information was not provided by old AMF, the AMF selects a UDM. Initial AMF may send to UDM a message such as Nudm_SDM_Get (an access type indication, SUPI, Slice Selection Subscription data). In an example, the access type indication may comprise N3GPP access type indication, and/or the like. The initial AMF may request UE's Slice Selection Subscription data from UDM by invoking the Nudm_SDM_Get service operation. UDM may get this information from UDR by Nudr_DM_Query (SUPI, Slice Selection Subscription data). The UDM may send to initial AMF: Response to Nudm_SDM_Get. The AMF gets the Slice Selection Subscription data including Subscribed S-NSSAIs. In an example, the UDM may respond with slice selection data to initial AMF. The Initial AMF may send to a NS SF: Nnssf_NSSelection_Get (the access type indication (e.g., for N3GPP access type, and/or the like), Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI). If there is a need for slice selection, e.g., the initial AMF cannot serve all the S-NSSAI(s) from the Requested NSSAI permitted by the subscription information, or for the underlay access type, the initial AMF may invoke the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the Network Slice Simultaneous Registration Group (NSSRG) Information for the S-NSSAIs of the network, including information whether the UE has indicated support of the subscription-based restrictions to simultaneous registration of network slices, and whether the UDM has indicated to provide all subscribed S-NSSAIs for non-supporting UEs.

In an example, the NSSF may send the AMF a response to Nnssf_NSSelection_Get (AMF Set or list of AMF addresses, Allowed NSSAI for the N3GPP access type, [Mapping Of Allowed NSSAI for the N3GPP access type], Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s)], [Configured NSSAI for the Serving PLMN, SNPN, NPN, the network, the overlay network, the N3GPP network, and/or the like], [Mapping Of Configured NSSAI]).

The NSSF may return to the AMF allowed NSSAI for the N3GPP access type, [Mapping of Allowed NSSAI for the underlay access type], the Allowed NSSAI for the first access type, optionally the Mapping of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s) that may be employed for access of the UE via underlay access. It may also return information regarding rejection causes for S-NSSAI(s) not included in the Allowed NSSAI. The NSSF may return Configured NSSAI for the Serving PLMN (e.g., network), and the associated mapping of the Configured NSSAI. If the NSSRG information was included in the request, the NSSF provides the Configured NSSAI.

In an example embodiment, based on local policies, the AMF may determine or may decide to establish AM Policy Association with the PCF. If the AMF has not yet obtained Access and Mobility policy for the UE or if the Access and Mobility policy in the AMF are no longer valid, the AMF requests the PCF to apply operator policies for the UE from the PCF. The AMF sends Npcf_AMPolicyControl_Create to the PCF or (V-)PCF to establish an AM policy control association with the PCF. The request may comprise the following information: policy association request, allowed S-NSSAIs for the N3GPP access (e.g., n3gAllowedSnssais), SUPI, Internal Group, subscription notification indication and, if available, Service Area Restrictions, RESP index, Subscribed UE-AMBR, List of Subscribed UE-Slice-MBR, the Allowed NSSAI, Target NSSAI, GPSI which are retrieved from the UDM during the update location procedure, and may include Access Type and RAT Type, PEI, ULI, UE time zone, and Serving Network (PLMN ID, or PLMN ID and NID, and/or the like).

In an example embodiment, when AMF utilizes an NWDAF, it may add the NWDAF serving the UE identified by the NWDAF instance ID. Per NWDAF service instance the Analytics ID(s) are also included. The PCF may respond to the Npcf_AMPolicyControl_Create service operation. The PCF may provide Access and mobility related policy information (e.g. Service Area Restrictions) for the N3GPP access type. In an example, the PCF may provide Policy Control Request Trigger of AM Policy Association to AMF. In the non-roaming case, the PCF may subscribe to Analytics from NWDAF. The PCF may register to the BSF as the PCF that handles the AM Policy Association for this UE. This is performed by using the Nbsf_Management_Register operation, providing as inputs the UE SUPI/GPSI and the PCF identity. The AMF deploys the Access and mobility related policy information which includes storing the Service Area Restrictions and Policy Control Request Trigger of AM Policy Association, provisioning Service Area Restrictions to the UE and provisioning the RFSP index, the UE-AMBR, List of UE-Slice-MBR, Service Area Restrictions to the N3IWF and request for notification of SM Policy association establishment and termination to a list of (DNN, S-NSSAI)(s) together with PCF for the UE binding information.

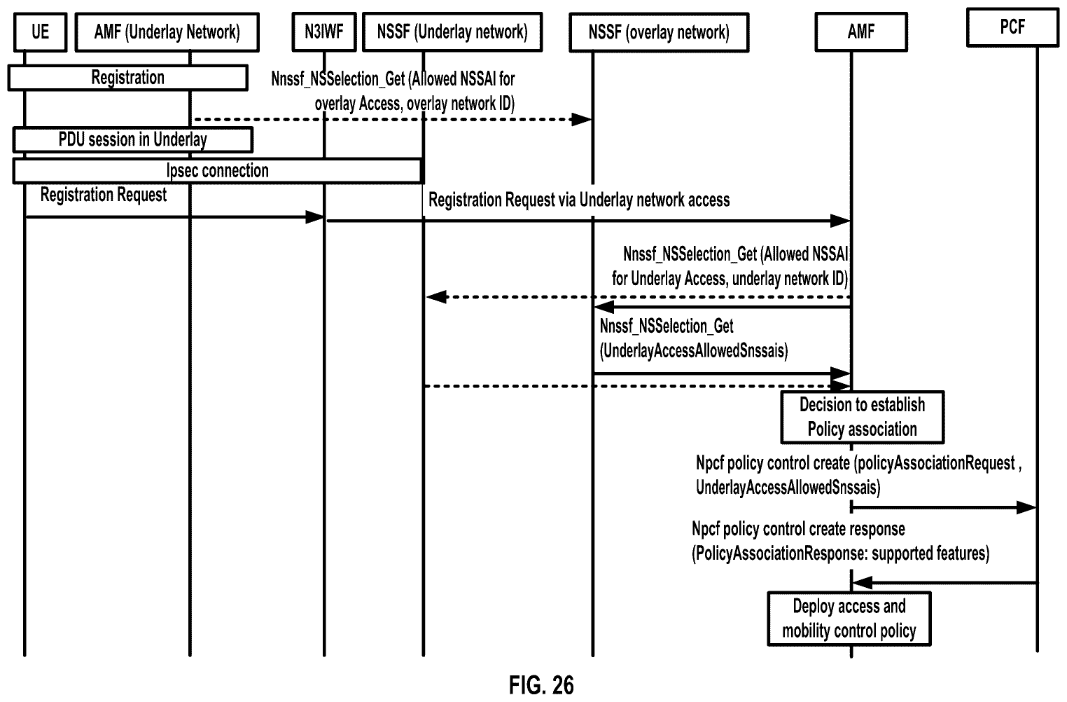

FIG. 26 may depict an example access request procedure of the UE with the overlay network via the underlay network in accordance with embodiments of the present disclosure. The UE may establish a PDU session with the underlay network after successful registration with the underlay network. The UE may employ the PDU session of the underlay network to establish an IPsec connection with the N3IWf of the overlay network. In an example, the UE may perform an access request procedure or registration request procedure with the overlay network. The UE may send to the N3IWF of the overlay network a registration request message, an access request message, an AN message, and/or the like. In an example, the AN message may comprise an indication that access of the UE is via the underlay network, the identifier of the underlay network, and/or the like. In an example, the AN message may comprise (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behavior], [UE paging probability information], [UE Policy Container (the list of PSIs, indication of UE support for ANDSP and the operating system identifier)] and [UE Radio Capability ID], [Release Request indication], [Paging Restriction Information], PEI, [Network Slice Simultaneous Registration Group (NSSRG) handling support indication], [PLMN with Disaster Condition])).

In an example, the N3IWF may send to the AMF an N2 message (e.g., comprising N2 parameters, registration request, [LTE-M Indication of the underlay network base station], and/or the like. When NG-RAN is used in the underlay network, the N2 parameters may comprise the identifier of the underlay network, Selected PLMN ID (or PLMN ID and NID, SNPN ID, and/or the like), Location Information and Cell Identity related to the cell in which the UE is camping in coverage of the underlay network, UE Context Request which indicates that a UE context including security information needs to be setup at the N3IWF.

In an example embodiment, the N3IWF may send the registration request message within an Initial UE message to the initial AMF (e.g., AMF 1). If the initial AMF needs UE's subscription information to decide whether to reroute the Registration Request and UE's slice selection subscription information was not provided by old AMF, the AMF selects a UDM. Initial AMF may send to UDM a message such as Nudm_SDM_Get (an access type indication, SUPI, Slice Selection Subscription data). In an example, the access type indication may comprise underlay access type indication, the identifier of the underlay network, and/or the like. The initial AMF may request UE's Slice Selection Subscription data from UDM by invoking the Nudm_SDM_Get service operation. UDM may get this information from UDR by Nudr_DM_Query (SUPI, Slice Selection Subscription data). The UDM may send to initial AMF: Response to Nudm_SDM_Get. The AMF gets the Slice Selection Subscription data including Subscribed S-NSSAIs. In an example, the UDM may respond with slice selection data to initial AMF.

In an example, the AMF or the Initial AMF may send to a NSSF (e.g., the NSSF of the overlay network or the NSSF of the underlay network): Nnssf_NSSelection_Get (the access type indication (e.g., for underlay access type, the identifier of the underlay network, and/or the like), Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI). If there is a need for slice selection, e.g., the initial AMF cannot serve all the S-NSSAI(s) from the Requested NSSAI permitted by the subscription information, or for the underlay access type, the initial AMF may invoke the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the Network Slice Simultaneous Registration Group (NSSRG) Information for the S-NSSAIs of the network, including information whether the UE has indicated support of the subscription-based restrictions to simultaneous registration of network slices, and whether the UDM has indicated to provide all subscribed S-NSSAIs for non-supporting UEs.

In an example, the NSSF may send the AMF a response to Nnssf_NSSelection_Get (AMF Set or list of AMF addresses, Allowed NSSAI for the underlay access type, [Mapping Of Allowed NSSAI for the underlay access type], Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s)], [Configured NSSAI for the Serving PLMN, SNPN, NPN, the network, the overlay network, the underlay network, and/or the like], [Mapping Of Configured NSSAI]).

The NSSF may return to the AMF allowed NSSAI for the underlay access type, [Mapping of Allowed NSSAI for the underlay access type], the Allowed NSSAI for the first access type, optionally the Mapping of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s) that may be employed for access of the UE via underlay access. It may also return information regarding rejection causes for S-NSSAI(s) not included in the Allowed NSSAI. The NSSF may return Configured NSSAI for the Serving PLMN (e.g., network), and the associated mapping of the Configured NSSAI. If the NSSRG information was included in the request, the NSSF provides the Configured NSSAI.

In an example embodiment, the AMF may perform an AM policy association establishment/modification. If the AMF selects a new PCF or (V-)PCF, the AMF may perform AM Policy Association Establishment with the selected PCF or (V-)PCF. If the PCF identified by the PCF ID or (V-)PCF ID included in UE context from the old AMF is used, the new AMF performs AM Policy Association Modification with the PCF. If the AMF notifies the Mobility Restrictions (e.g. UE location) to the PCF for adjustment, or if the PCF updates the Mobility Restrictions itself due to some conditions (e.g., application in use, time and date), the PCF may provide the updated Mobility Restrictions to the AMF. If the subscription information includes Tracing Requirements, the AMF may provide the PCF with Tracing Requirements. If the AMF supports DNN replacement, the AMF may provide the PCF with the Allowed NSSAI and, if available, the Mapping of Allowed NSSAI. If the PCF supports DNN replacement, the PCF provides the AMF with triggers for DNN replacement.

In an example embodiment, based on local policies, the AMF of the overlay network may determine or may decide to establish AM Policy Association with the PCF of the overlay network. If the AMF has not yet obtained Access and Mobility policy for the UE or if the Access and Mobility policy in the AMF are no longer valid, the AMF requests the PCF to apply operator policies for the UE from the PCF of the overlay network. The AMF sends Npcf_AMPolicyControl_Create to the PCF or (V-)PCF to establish an AM policy control association with the PCF. The request may comprise the following information: policy association request, allowed S-NSSAIs for the underlay access type, the identifier of the underlay network (underlay network ID) SUPI, Internal Group, subscription notification indication and, if available, Service Area Restrictions, RESP index, Subscribed UE-AMBR, List of Subscribed UE-Slice-MBR, the Allowed NSSAI, Target NSSAI, GPSI which are retrieved from the UDM during the update location procedure, and may include Access Type and RAT Type, PEI, ULI, UE time zone, and Serving Network (PLMN ID, or PLMN ID and NID, and/or the like).

In an example embodiment, when AMF utilizes an NWDAF, it may add the NWDAF serving the UE identified by the NWDAF instance ID. Per NWDAF service instance the Analytics ID(s) are also included. The PCF may respond to the Npcf_AMPolicyControl_Create service operation. The PCF may provide Access and mobility related policy information (e.g. Service Area Restrictions). In an example, the PCF may provide Policy Control Request Trigger of AM Policy Association to AMF. In the non-roaming case, the PCF may subscribe to Analytics from NWDAF. The PCF may register to the BSF as the PCF that handles the AM Policy Association for this UE. This is performed by using the Nbsf_Management_Register operation, providing as inputs the UE SUPI/GPSI and the PCF identity. The AMF deploys the Access and mobility related policy information which includes storing the Service Area Restrictions and Policy Control Request Trigger of AM Policy Association, provisioning Service Area Restrictions to the UE and provisioning the RFSP index, the UE-AMBR, List of UE-Slice-MBR, Service Area Restrictions to the NG-RAN and request for notification of SM Policy association establishment and termination to a list of (DNN, S-NSSAI)(s) together with PCF for the UE binding information.

In an example embodiment as depicted in FIG. 26, the underlay network may select network slices based on an access request from the UE. The access request may comprise an indication that the UE is requesting access to the underlay network to access the overlay network. In an example, the access request may comprise an identifier of the overlay network. In an example, an AMF of the underlay network may perform a slice selection with the NSSF (e.g., the NSSF of the underlay network or the NSSF of the overlay network). The AMF may send the Nnssf_NSSelection_Get message to the NSSF. The message may comprise the indication that access of the UE is for accessing the overlay network via the underlay network. In an example, the NSSF of the underlay network may send a slice selection request to the NSSF of the overlay network and receive allowed network slices for access of the UE to the overlay network via the underlay network.

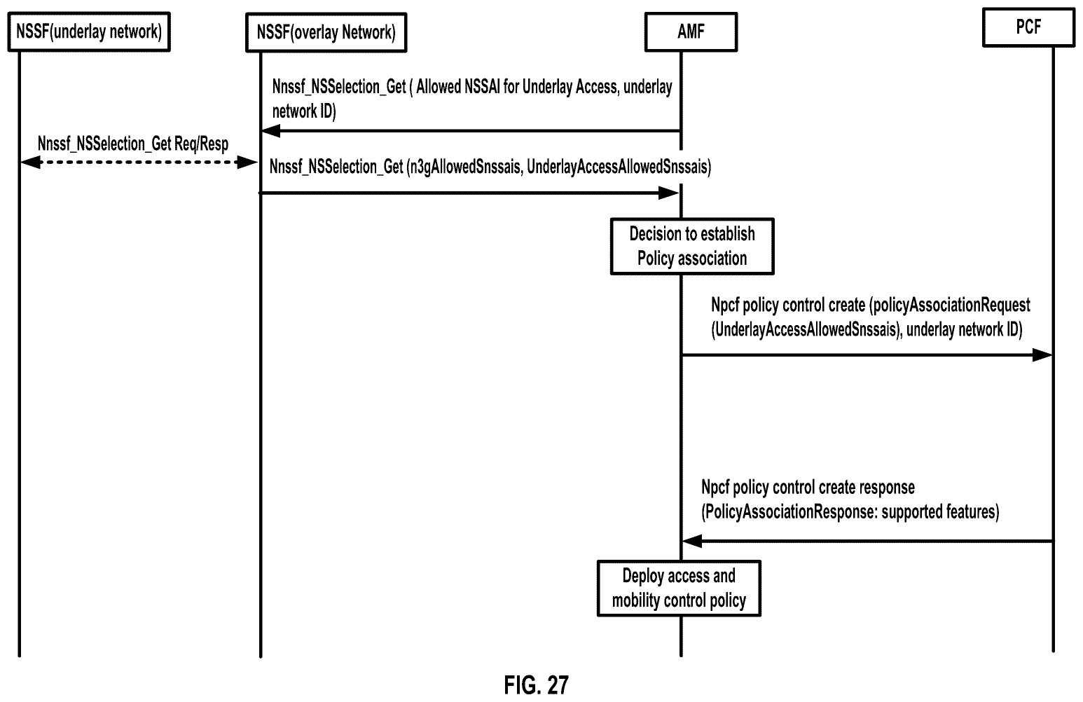

FIG. 27 may depict an example network slice selection and policy association establishment procedure in accordance with embodiments of the present disclosure. In an example, services offered by the NSSF may be as follows.

Network slice selection e.g., Nnssf_NSSelection: this service enables Network Slice selection in both the Serving PLMN and the HPLMN, underlay network overlay network, SNPN, NPN and/or the like. NF service consumers may be the AMF, NSSF, V-NSSF, and/or the like. Network slice availability service e.g., Nnssf_NSSAIAvailability: this service enables to update the S-NSSAI(s) the NF service consumer (e.g., AMF) supports on a per TA basis on the NSSF and to subscribe and notify any change in status, on a per TA basis, of the SNSSAIs available per TA (unrestricted) and the restricted S-NSSAI(s) per PLMN in that TA in the serving PLMN of the UE. In an example, the network slice availability may provide network slice (NSSAI, S-NSSAI, NSI and/or the like) support information on a per underlay network basis. For example, the network slice support may be different when the UE is accessing the overlay network via underlay network 1 and when the UE is accessing the overlay network via underlay network 2.

In an example, the Nnssf_NSSelection service may be employed by an NF Service Consumer (e.g., AMF or NSSF in a different network) to retrieve the information related to network slice in the non-roaming and roaming case. It may enable the NSSF to provide to the AMF the Allowed NSSAI and the Configured NSSAI for the network (e.g., PLMN, SNPN, underlay network, overlay network and/or the like). The NF service consumer may discover the NSSF based on the local configuration. The NSSF in a different network or PLMN may be discovered based on the self-constructed FQDN.

In an example, for the Nnssf_NSSelection service the following service operations may be defined: Get operation: may be invoked by the AMF to retrieve: The slice selection information including the allowed NSSAI, Configured NSSAI, target AMF Set or the list of candidate AMF(s); The Mapping Of Allowed NSSAI; The Mapping Of Configured NSSAI; NSI ID(s) associated with the Network Slice instances of the Allowed NSSAI; NRF(s) to be used to select NFs/services within the selected Network Slice instance(s) and NRF to be used to determine the list of candidate AMF(s) from the AMF Set, during Registration procedure and Information on whether the S-NSSAI(s) not included in the Allowed NSSAI which were part of the Requested NSSAI are rejected in the network or serving PLMN or in the current TA. The Target NSSAI can include the S-NSSAI(s). The NRF to be used to select NFs/services within the selected network slice instance, and optionally the NSI ID associated with the S-NSSAI provided in the input, during the PDU Session Establishment procedure. The slice mapping information includes the mapping of S-NSSAI(s) of the underlay network to overlay network S-NSSAI(s) (or vice versa), or the mapping of S-NSSAI(s) of the VPLMN to corresponding HPLMN S-NSSAI(s).

In an example embodiment, get service operation of Nnssf_NSSelection service may comprise the following: in this procedure, the NF Service Consumer (e.g., the AMF) may retrieve the slice selection information including the Allowed NSSAI, Configured NSSAI, target AMF Set or the list of candidate AMF(s) and other information. The AMF may send a Get request message to the NSSF. In an example the Get request message may comprise the access type indication (e.g., for underlay access type), the identifier of the underlay network, and/or the like. In an example the slice selection information may be based on the access type indication being the underlay access type. In an example, the AMF may send a GET request to the NSSF. If the AMF wants to retrieve the slice selection information, one or more of the following parameters may be included as query parameters: the access type indication (e.g., for underlay access type), the identifier of the underlay network, and/or the like, requested NSSAI and Subscribed S-NSSAI(s) with the indication if marked as default S-NSSAI and the associated subscribed NSSRG information and optionally UE support of subscription-based restrictions to simultaneous registration of network slice feature Indication included in the slice-info-request-for-registration, PLMN ID of the SUPI, TAI, NF type of the NF service consumer, Requester ID.

If the AMF wants to retrieve the slice mapping information, the following parameters may be included as query parameters: sNssaiForMapping IE and requestMapping IE included in the slice-info-request-for-registration, PLMN ID of the SUPI, TAI, NF type of the NF service consumer and Requester ID. On success, “200 OK” may be returned to the AMF when the NSSF is able to find authorized network slice information for the requested network slice selection information, the response body shall include a payload body containing at least the allowed S-NSSAIs for the underlay access type (underlayAccessAllowedSnssais), Allowed NSSAI, target AMF Set or the list of candidate AMF(s); the payload body may additionally contain a target AMF Service Set and target NSSAI. If subscribed NSSRG list is provided, the NSSF may provide the compatible S-NSSAIs in the Allowed NSSAI. “200 OK” may be returned when the NSSF is able to find the requested slicing mapping information, the response body may include a payload body containing the mapping of S-NSSAI(s) of the overlay network to the underlay network, the underlay network to the overlay network, VPLMN to corresponding HPLMN S-NSSAI(s) included in the allowedNssaiList IE.

In an example, if no slice instances can be found for the requested slice selection information or the requested slice mapping information, then the NSSF may return a 403 Forbidden response with the “ProblemDetails” IE containing the Application Error “SNSSAI_NOT_SUPPORTED”. On failure or redirection, the NSSF may return one of the HTTP status codes together with the response body.

In an example embodiment, get service operation of Nnssf_NSSelection service may be employed during the PDU session establishment procedure, configuration update procedure, and/or the like. In this procedure, the NF Service Consumer (e.g., the AMF) may retrieve the NRF and the NSI ID of the network slice instance. The NF Service consumer (e.g. AMF or NSSF in the different network) may send a GET request to the NSSF. The request may include query parameters may comprise the access type indication (e.g., for underlay access type), the identifier of the underlay network, and/or the like, at least S-NSSAI, S-NSSAI from the underlay network that maps to the S-NSSAI from the Allowed NSSAI of the overlay network, at least S-NSSAI, S-NSSAI from the overlay network that maps to the S-NSSAI from the Allowed NSSAI of the underlay network, at least S-NSSAI, S-NSSAI from the HPLMN that maps to the S-NSSAI from the Allowed NSSAI of the Serving PLMN, the NF type of the NF service consumer, Requester ID and non-roaming/LBO roaming/HR roaming indication. For the request towards an NSSF in the Serving PLMN, the query parameters may comprise also contain the identifier of the network (e.g., underlay network or overlay network), the PLMN ID or SNPN ID of the SUPI and TAI. On success, “200 OK” may be returned when the NSSF is able to find network slice instance information for the requested network slice selection information, the response body shall include a payload body containing at least the NRF to be used to select NFs/services within the selected Network Slice instance. If no slice instances can be found for the requested slice selection information, then the NSSF may return a 403 Forbidden response with the “ProblemDetails” IE containing the Application Error “SNSSAI_NOT_SUPPORTED”. On failure or redirection, the NSSF may return one of the HTTP status codes together with the response body.

In an example embodiment, Nnssf_NSSAIAvailability Service operation may be employed by the network. The Nnssf_NSSAIAvailability service may be employed by the NF service consumer (e.g., the AMF) to update the S-NSSAI(s) the AMF supports on: a per underlay network basis, per access type basis, per TA basis on the NSSF, and/or the like; subscribe and unsubscribe the notification of any changes to the NSSAI availability information on a per underlay network basis, on a per access type basis, on a per TA basis, of the S-NSSAIs available per TA (unrestricted) and the restricted S-NSSAI(s) per network e.g., SNPN, PLMN, and/or the like in that TA in the serving PLMN or SNPN of the UE. For the Nnssf_NSSAIAvailability service the following service operations may be defined: Update; Subscribe; Unsubscribe; Notify; Delete; Options.

In an example, when a UE registers and a UE context is being established, the AMF may obtain service area restrictions, RESP index, subscribed UE-AMBR, subscribed UE-Slice-MBR(s) and GPSI(s) from the UDM during the Access and Mobility Subscription Data retrieval procedure and the allowed NSSAI from local configuration or from the NSSF during the slice selection procedure and may decide based on local policies whether to request policies from the PCF. To request policies from the PCF, the NF service consumer (e.g. AMF) may send the HTTP POST request. The post request may be a policy association establishment request message sent from the AMF to the PCF, or sent from the SMF to the PCF. The HTTPPOST request message may comprise the identifier of the underlay network that the UE employs to access the overlay network, the access type indication for underlay access type, and/or the like.

In an example, during an access request, registration or configuration update procedure, based on local policies, the AMF of the overlay network may determine or may decide to establish AM Policy Association with the PCF of the overlay network. If the AMF has not yet obtained Access and Mobility policy for the UE or if the Access and Mobility policy in the AMF are no longer valid, the AMF may request the PCF to apply operator policies for the UE from the PCF of the overlay network. The AMF may send Npcf_AMPolicyControl_Create request to the PCF or (V-)PCF to establish an AM policy control association with the PCF. The request may comprise the following information: policy association request, allowed S-NSSAIs for the underlay access type (e.g., the allowed S-NSSAIs for the underlay access type that was received from the NSSF based on the access type indication of the underlay access type), the identifier of the underlay network (underlay network ID), SUPI, Internal Group, subscription notification indication and, if available, Service Area Restrictions, RESP index, Subscribed UE-AMBR, List of Subscribed UE-Slice-MBR, the Allowed NSSAI, Target NSSAI, GPSI which are retrieved from the UDM during the update location procedure, and may include Access Type and RAT Type, PEI, ULI, UE time zone, and Serving Network (PLMN ID, or PLMN ID and NID, and/or the like).

In an example embodiment, the PCF may respond to the Npcf_AMPolicyControl_Create service operation. The PCF may provide Access and mobility related policy information (e.g. Service Area Restrictions, supported features, policy information, and/or the like). In an example, the PCF may provide Policy Control Request Trigger of AM Policy Association to AMF. In the non-roaming case, the PCF may subscribe to Analytics from NWDAF. The PCF may register to the BSF as the PCF that handles the AM Policy Association for this UE. This is performed by using the Nbsf_Management_Register operation, providing as inputs the UE SUPI/GPSI and the PCF identity. The AMF deploys the Access and mobility related policy information which includes storing the Service Area Restrictions and Policy Control Request Trigger of AM Policy Association, provisioning Service Area Restrictions to the UE and provisioning the RFSP index, the UE-AMBR, List of UE-Slice-MBR, Service Area Restrictions to the NG-RAN and request for notification of SM Policy association establishment and termination to a list of (DNN, S-NSSAI)(s) together with PCF for the UE binding information.

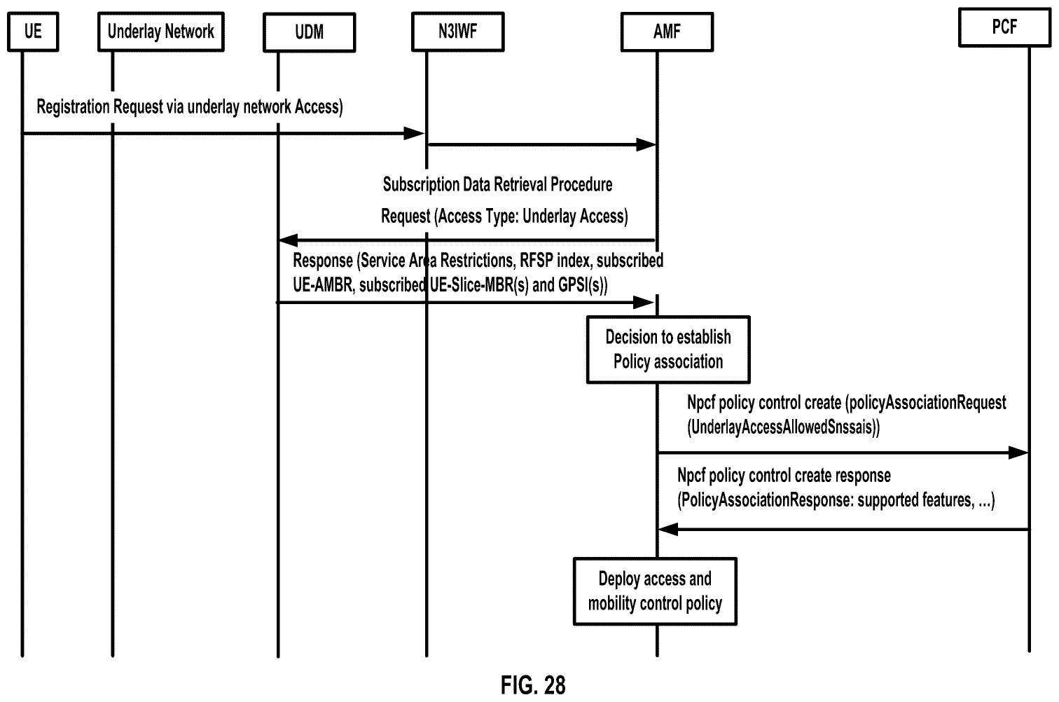

FIG. 28 may depict an example registration procedure in accordance with embodiments of the present disclosure. In an example, the AMF may receive from the UE the access request comprising the underlay access indication, the underlay network ID, and/or the like. In an example, the AMF or a network function may send a request to the UDM to request subscription information based on the underlay access type. The underlay access type indicates the UE accesses the network via the underlay network. The NF may send to the UDM or to the UDR a request comprising the underlay access type indication, the underlay network ID, and/or the like. In an example, the request may be a subscription data retrieval request. In an example, the UDM may send a response the NF or the AMF that may comprise the subscription data for the access of the UE via underlay access. The subscription data may comprise allowed network slice or allowed S-NSSAIs for the underlay access. The AMF may employ the subscription data for the underlay access to establish a policy association with the PCF and send the policy association establishment request to the PCF that may comprise the allowed S-NSSAIs for the underlay access.

During the registration procedure or access request procedure as per an example embodiment, if the AMF does not have subscription data for the UE, the AMF may retrieve from the UDM, the Access and Mobility Subscription data, SMF Selection Subscription data, UE context in SMF data and LCS mobile origination using Nudm_SDM_Get. If the AMF already has subscription data for the UE but the steer of roaming (SoR) Update Indicator in the UE context requires the AMF to retrieve SoR information depending on the NAS Registration Type (“Initial Registration” or “Emergency Registration”), the AMF retrieves the Steering of Roaming information using Nudm_SDM_Get. This requires that UDM may retrieve this information from UDR by Nudr_DM_Query. After a successful response is received, the AMF may subscribe to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE.

The AMF or the new AMF may provide the Access Type it serves for the UE to the UDM and the Access Type is set to the underlay access type. In an example, the AMF may send the underlay network ID to the UDM. The underlay network ID is associated with the underlay access type and the underlay network that the UE employs to access the overlay network. The UDM may store the associated Access Type and underlay network ID together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same network, the new AMF sends a separate/independent Nudm_UECM_Registration to update UDM with Access Type=underlay access type set to access used in the old AMF, after the old AMF relocation is successfully completed.

The new AMF creates a UE context for the UE after getting the Access and Mobility Subscription data from the UDM. The Access and Mobility Subscription data includes whether the UE is allowed to include NSSAI in signaling via the underlay access and IPsec related signaling or in the 3GPP access RRC Connection Establishment in clear text. The Access and Mobility Subscription data may include Enhanced Coverage Restricted information. If received from the UDM and the UE included support for restriction of use of Enhanced Coverage, the AMF may determines whether Enhanced Coverage is restricted or not for the UE and stores the updated Enhanced Coverage Restricted information in the UE context.

The AMF may, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.

When the UDM stores the associated Access Type (e.g., the underlay access type, 3GPP, and/or the like) together with the serving AMF, it will cause the UDM to initiate a Nudm_UECM_Deregistration Notification to the old AMF corresponding to the same access e.g., underlay access, if one exists.

In an example embodiment, an access and mobility management function (AMF) of an overlay network may receive from an interworking function e.g., a non-3GPP interwork function (N3IWF), a registration request message indicating access of the wireless device to the overlay network via an underlay network. The registration request message may be an access request message. The AMF may send to a selection function node such as a network slice selection function (NSSF), a request for selection of allowed network slices for the access of the wireless device to the overlay network via the underlay network. In an example, the AMF may receive from the NSSF, one or more network slice identifiers of the one or more allowed network slices for access of the wireless device to the overlay network via the underlay network. In an example, the AMF may send to a policy and charging control function (PCF), a policy association establishment request message comprising the one or more network slice identifiers.

In an example, the AMF may determine to establish policy association for access of the wireless device via the underlay network. In an example, the AMF may receive from the wireless device via the N3IWF, the registration request message. In an example, the AMF may receive from the PCF, a policy association establishment response message comprising policy information (e.g., comprising supported features, the URSP, and/or the like). In an example, the AMF may determine to deploy access and mobility control policy. In an example, the deployment of access and mobility control policy may comprise one or more of storing the service area restrictions and policy control request trigger of AM Policy Association, provisioning of service area restrictions to the UE, provisioning the RFSP index, provisioning the UE-AMBR, provisioning a list of UE-Slice-MBR, provisioning service area restrictions to the wireless device, to the N3IWF, or to a base station. In an example, the NSSF may be a NSSF of the overlay network. In an example, the NSSF may be a NSSF of the underlay network. In an example, the request (message) for selection of allowed network slices may comprise an identifier of the underlay network. In an example, the registration request message may comprise an identifier of the underlay network. In an example, the AMF may send to a unified data management (UDM), a subscription data request. The subscription data request may comprise an access type indication for underlay access of the wireless device to the overlay network. The subscription data request may comprise an identifier of the underlay network. In an example, the AMF may receive from the UDM subscription data for access of the wireless device to the overlay network via the underlay network. In an example, the subscription data may comprise at least one or more of: service area restrictions, Subscribed UE slice maximum bitrate (MBR), One or more GPSIs. In an example, the AMF may receive from the PCF, policy information comprising UE route selection policy (URSP). The URSP may comprise one or more DNNs that the wireless device is allowed for the underlay access type. The URSP may comprise one or more network slices that the wireless device may select to access the overlay network via user plane connection of the underlay network. The URSP may comprise one or more configuration parameters for establishment a PDU session with the overlay network via the underlay network. In an example, the request for selection of allowed network slices may comprise at least one of: an access type comprising an underlay access type indication, an access type comprising a Non-3GPP access type, an access type comprising a 3GPP access type, and/or the like. In an example, the request for selection of allowed network slices may comprises a cell identifier of a base station of the underlay network via which the UE accesses the overlay network.

In an example embodiment, an access and mobility management function (AMF) of an overlay network may receive from an interworking function node e.g., a non-3GPP interwork function (N3IWF), a registration request message indicating access of the wireless device to the overlay network via an underlay network. In an example, the AMF may send to a network slice selection function (NSSF), a request for selection of allowed network slices for the access of the wireless device to the overlay network via the underlay network. In an example, the AMF may receive from the NSSF, one or more network slice identifiers of the one or more allowed network slices for access of the wireless device to the overlay network via the underlay network.

In an example embodiment, an access and mobility management function (AMF) of an overlay network may receive from a non-3GPP interwork function (N3IWF), a registration request message indicating access of the wireless device to the overlay network via an underlay network. In an example, the AMF may send to a policy and charging control function (PCF), a policy association establishment message comprising one or more network slice identifiers for the access of the wireless device to the overlay network via the underlay network. In an example, the AMF may receive from the PCF, policy information for the access of the wireless device to the overlay network via the underlay network.

In an example embodiment, an access and mobility management function (AMF) of an overlay network may receive from a non-3GPP interwork function (N3IWF), a registration request message comprising an underlay access type indication. In an example, the AMF may send to a network slice selection function (NSSF), a first message requesting selection of a network slice for the underlay access type. In an example, the AMF may receive from the NSSF, a second message comprising a list of allowed single network slice selection assistance information (S-NSSAIs) for access of the wireless device to the overlay network via a user plane connection of the underlay network. In an example, the AMF may send to a policy and charging control function (PCF) a third message to establish a policy association. The third message may comprise the list of allowed S-NSSAIs for access of the wireless device via the underlay network.

In an example embodiment, an access and mobility management function (AMF) of an overlay network may receive from a non-3GPP interwork function (N3IWF), an access request message, a service request message, a PDU session establishment request message, a registration request message, and/or the like, comprising an underlay access type indication. In an example, the AMF may send to a network slice selection function (NSSF), a first message requesting selection of a network slice for the underlay access type. In an example, the AMF may receive from the NSSF, a second message comprising a list of allowed single network slice selection assistance information (S-NSSAIs) for underlay access of the wireless device to the overlay network. In an example, the AMF may send to a policy and charging control function (PCF) a third message to establish a policy association. The third message may comprise the list of allowed S-NSSAIs for the underlay access type, or underlay access of the wireless device to the overlay network.

What is claimed is:

1. A method comprising:
sending, by an access and mobility management function (AMF) of an overlay network, to a network slice selection function (NSSF), a request for selection of one or more allowed network slices of a wireless device, wherein the request for selection indicates that an access of the wireless device to the overlay network is via an underlay network; and
receiving, by the AMF from the NSSF, one or more network slice identifiers of the one or more allowed network slices for the access of the wireless device to the overlay network via the underlay network.

2. The method of claim 1, further comprising receiving, by the AMF from the wireless device via a non-3GPP interwork function (N3IWF), a registration request message.

3. The method of claim 2, wherein the registration request message indicates the access of the wireless device to the overlay network via the underlay network.

4. The method of claim 2, wherein the registration request message comprises an identifier of the underlay network or an underlay access type indication.

5. The method of claim 2, further comprising sending, by the AMF to the wireless device, via the N3IWF, a registration accept message.

6. The method of claim 1, further comprising sending, by the AMF to a policy and charging control function (PCF), a policy association establishment message comprising the one or more network slice identifiers for the wireless device.

7. The method of claim 6, wherein the policy association establishment message indicates that the access of the wireless device to the overlay network is via the underlay network.

8. The method of claim 6, further comprising receiving, by the AMF, a policy association establishment response comprising policy information.

9. The method of claim 8, wherein the policy information further comprises supported features for a UE route selection policy (URSP).

10. The method of claim 9, wherein the URSP comprises one or more data network names (DNNs) that the wireless device is allowed for an underlay access type.

11. An access and mobility management function (AMF) of an overlay network comprising one or more processors and memory storing instructions that, when executed by the one or more processors, cause the AMF to perform:
sending to a network slice selection function (NSSF), a request for selection of one or more allowed network slices of a wireless device, wherein the request for selection indicates that an access of the wireless device to the overlay network is via an underlay network; and
receiving, from the NSSF, one or more network slice identifiers of the one or more allowed network slices for the access of the wireless device to the overlay network via the underlay network.

12. The AMF of claim 11, further comprising receiving, by the AMF from the wireless device via a non-3GPP interwork function (N3IWF), a registration request message.

13. The AMF of claim 12, wherein the registration request message indicates the access of the wireless device to the overlay network via the underlay network.

14. The AMF of claim 12, wherein the registration request message comprises an identifier of the underlay network or an underlay access type indication.

15. The AMF of claim 12, further comprising sending, by the AMF to the wireless device, via the N3IWF, a registration accept message.

16. The AMF of claim 11, further comprising sending, by the AMF to a policy and charging control function (PCF), a policy association establishment message comprising the one or more network slice identifiers for the wireless device.

17. The AMF of claim 16, wherein the policy association establishment message indicates that the access of the wireless device to the overlay network is via the underlay network.

18. The AMF of claim 16, further comprising receiving, by the AMF, a policy association establishment response comprising policy information.

19. The AMF of claim 18, wherein the policy information further comprises supported features for a UE route selection policy (URSP).

20. A non-transitory computer-readable medium comprising instructions that, when executed by one or more processors, cause the one or more processors to perform:
sending, by an access and mobility management function (AMF) of an overlay network, to a network slice selection function (NSSF), a request for selection of one or more allowed network slices of a wireless device, wherein the request for selection indicates that an access of the wireless device to the overlay network is via an underlay network; and
receiving, by the AMF from the NSSF, one or more network slice identifiers of the one or more allowed network slices for the access of the wireless device to the overlay network via the underlay network.
